(19) United States
(12) Patent Application Publication
(10) Pub. No.: US 2025/0371225 A1
(43) Pub. Date: Dec. 4, 2025

(54) Method and Apparatus for Agentic digital-twin and System for Environmental-Infrastructure Prediction and Decision Support

(71) Applicant: MAIA Water Inc., Herndon, VA (US)

(72) Inventors: Keaton Lesnik, Portland, OR (US); Sudhir Murthy, Herndon, VA (US)

(73) Assignee: MAIA Water Inc., Herndon, VA (US)

(21) Appl. No.: 19/185,603

(22) Filed: Apr. 22, 2025

Related U.S. Application Data
(60) Provisional application No. 63/636,960, filed on Apr. 22, 2024.

(51) Int. Cl. G06F 30/27; G06F 113/08; G06F 119/14

(52) U.S. Cl. CPC G06F 30/27; G06F 2113/08; G06F 2119/14

(57) ABSTRACT

A portable agent package apparatus for coupling to one or more environment, energy or water infrastructure or water body sensors produce timestamped or temporal process data, includes a physics surrogate world model trained to predict at least one hydraulic, chemical, or biological state variable of the sensed water system, a connection memory that stores metadata describing data source identifiers, units, and sampling cadence, pointers to available analytical tools or peer agent packages, or streams of operational experience or a hierarchical options library, an emotion tensor continuously encodes normalized metrics comprising at least one of model accuracy, computational load, data quality, latency, and uncertainty, or further including an exploration bonus channel, a value estimate error, an anomaly score, or an alignment divergence flag, and a bidirectional, authenticated communication interface that receives the temporal or timestamped process data from the one or more sensors, transmits Memo updates, and accepts goal directives.

### TECHNICAL FIELD

The present invention relates to the field of environmental-infrastructure and, more particularly, to an agent-based digital-twin method and apparatus and a hierarchical system for infrastructure prediction and decision support.

### BACKGROUND

The present invention relates to digital twin apparatuses and systems for water, wastewater, stormwater collection and treatment systems, aquaculture, and various environmental domains including air and soil management, as well as energy infrastructure. More specifically, the invention concerns distributed artificial intelligence systems utilizing agent-based architectures with portable “Agent-Packages” as fundamental building blocks that incorporate physics-surrogate world models, contextual memory structures, and health-emotion metrics for hierarchical monitoring, prediction, and decision support.

Effective management of complex, distributed energy, environmental and water infrastructure requires timely, predictive insights derived from comprehensive data. However, conventional digital twin and analytics systems face significant limitations that hinder their effectiveness in water infrastructure (henceforth any or all infrastructure using water as a medium) applications.

Traditional digital twin implementations are typically monolithic, computationally intensive, and confined to central servers. These centralized architectures create processing bottlenecks that struggle to execute high-fidelity simulations at speeds sufficient for real-time predictive insights or alerts (typically requiring conversational speed response times of 1-60 seconds, and depending on needs, time-scales and complexity, insights are needed within hours), particularly when handling multiple concurrent tasks. A key limitation is their reliance on computationally demanding mechanistic models, which are often too slow for real-time distributed applications. While centralization does offer advantages in terms of data consistency and simplified management, it prevents efficient propagation of situational awareness and predictive capabilities to distributed locations where they are often most needed. Centralization also poses security and resilience challenges where the compromise of a central architecture can impact propagation.

Existing systems face substantial challenges integrating heterogeneous data signals from diverse sources including SCADA systems, distributed control systems (DCS), laboratory information management systems (LIMS), advanced multi-parameter sensor platforms, satellite imagery, weather forecasts, unstructured operator logs, image/video feeds, and drone-collected observations. The difficulty in harmonizing these diverse data streams—with their inconsistent formats, varying sampling frequencies, and divergent quality characteristics—hinders the development of holistic situational awareness and accurate prediction of complex process states.

Conventional architectures lack localized analysis/prediction capabilities at the edge, where such capabilities would be most valuable for low-latency data validation, anomaly detection, and rapid response. This limitation is particularly acute when considering deployment on or near advanced multi-parameter sensor platforms, where local processing could significantly reduce data transmission requirements and enable faster reactions to changing conditions.

Data fragmentation across siloed systems like SCADA, LIMS, and GIS hinders comprehensive understanding of infrastructure operations. Similarly, analytical models—such as hydraulic versus water quality models or energy versus process performance analytics—frequently operate independently without effective integration mechanisms. The challenge becomes even more complex when attempting to integrate models that function at vastly different temporal and spatial scales, including climate, energy shed, airshed, watershed, collection system, and treatment process models. These diverse models typically employ incompatible interfaces, data formats, and temporal/spatial resolutions. Furthermore, representing and integrating data and model outputs based on explicit spatial (x, y, z) and temporal (t) coordinates across these disparate systems and scales remains a significant technical hurdle. This fragmentation prevents holistic cross-scale analysis that would be valuable for understanding critical relationships, such as how potential climate change impacts might cascade down to affect treatment plant performance.

Existing digital twins typically lack advanced mechanisms for monitoring their own health, performance, and accuracy. Without internal health monitoring or performance feedback loops, these systems cannot self-assess or adapt to changing conditions, data quality issues, or model drift. This limitation prevents the implementation of sophisticated control systems that could use health metrics as continuous, quantitative signals for system control and adaptation.

The rigid deployment architecture of conventional digital twins restricts their practical utility. Traditional implementations are typically fixed in their deployment locations and configurations, making them difficult to update, migrate, or scale in response to changing requirements. This inflexibility poses particular challenges in energy/environment/water infrastructure environments, which often encompass geographically distributed assets with varying computational resources and connectivity.

Existing systems frequently lack intelligent, hierarchical mechanisms for coordinating complex analytical workflows, mediating interactions between multi-scale models, or selecting appropriate model types based on real-time context and analytical needs. Specifically, they lack the ability to dynamically select and orchestrate heterogenous models, including computationally efficient emulations, based on task requirements, real-time system health, and the spatial/temporal context of the data. This deficiency becomes particularly problematic when attempting to integrate detailed models of complex physical, chemical, and biological processes operating at different scales for comprehensive analysis of cross-scale impacts and interactions.

The interfaces for advanced analytical tools often prove unsuitable for non-specialist operators, with complex dashboards and limited support for natural language queries or automated report generation. This complexity hinders the practical application of system insights by the personnel who make day-to-day operational decisions.

Traditional systems lack mechanisms for managing resource consumption or incentivizing contribution in multi-tenant or collaborative environments. There is no tight coupling between agent creation/deployment and resource accounting/incentivization, which becomes increasingly important as systems scale across organizational boundaries. For example, traditional utilities (serving environmental and energy uses/needs) are disaggregated as enterprises within regions and host their own systems. There is a need to help build a uniform and standardized operations approach uniting software and hardware packages together to help regionalize (if needed), communicate (during emergencies) or to avoid unnecessary and avoidable replication (through collaboration).

These limitations underscore a significant need for a unified, extensible, and intelligent system architecture capable of overcoming existing shortcomings. Specifically, there is a need for: a portable, self-contained apparatus coupling rapid physics-surrogate models or emulations with contextual memory and health introspection; a flexible, hierarchical deployment model; an intelligent orchestration system managing complex workflows and dynamically selecting appropriate model types based on context and performance; a systematic approach for creating and managing efficient surrogate models and emulations; integrated, multi-tiered memory structures that include spatial temporal context; robust data fusion capabilities; adaptive mechanisms driven by quantitative performance feedback; intuitive interaction mechanisms; and governance mechanisms for managing resource usage and incentivizing collaboration in distributed deployments.

A critical component missing from current approaches is an effective tokenization framework that could incentivize feedback loops, improve system efficiency and health, and facilitate the propagation of models and tools across subsystem boundaries. Such a tokenization system would create economic incentives that drive continuous improvement and wider adoption of beneficial models throughout interconnected environmental and infrastructure systems.

The present invention addresses these needs through a novel agent-based digital twin architecture specifically designed for energy/environment/water infrastructure applications, leveraging computationally efficient emulations as a key component of its physics-surrogate world models and incorporating explicit spatial and temporal representation for integrated system management.

### SUMMARY OF THE INVENTION

The present disclosure provides an apparatus (the Agent-Package) and a hierarchical system architecture for advanced monitoring, prediction, analysis, autonomous learning, adaptive control, and decision support in energy/environment/water infrastructure (henceforth references to water infrastructure are exemplary and could likewise include similar applicable considerations for energy, environment (water is broadly a subset of environment) and transportation (henceforth, a subset of energy utilities/systems/management/infrastructure, including and not limited to use of chemical, electrical and mechanical energy) infrastructure). A linear infrastructure has similitudes amongst these utilities and can use similar apparatus to exemplary approaches used for water infrastructure (such as sewers, pipes, energy transmission, or roads/rails). Vertical infrastructure (such as plants use apparatus such as SCADA or DCU or sensing) that are similar to such needs (energy plants, water plants, stations/airports). The core innovation lies in the Agent-Package (AP): a lightweight, portable software unit containing a novel integrated core comprising three key components: (i) a physics-surrogate World Model (Mwm) configured to perform localized prediction or simulation and support centralized/on-device planning and scenario evaluation, often implemented as a computationally efficient emulation of a mechanistic model or physical process, (ii) a contextual Connection Memory (Mmem) configured to store contextual information about capabilities and connections including hierarchical options and skills for temporal abstraction, and (iii) an Emotion Tensor (Memo) quantifying operational health and providing signals for learning and exploration. This integrated core enables adaptive edge cognition, allowing the AP to autonomously select tools based on Mmem, adjust predictions based on Memo-flagged data quality, learn and update internal control policies based on environmental reward signals, and escalate goals efficiently. The system is configured to present and integrate data and model outputs based on explicit spatial (x, y, z) and temporal (t) coordinates, enabling comprehensive management of interconnected infrastructure and environmental domains such as watersheds, airsheds, and energysheds.

APs are deployed across a hierarchy: Nodes (data sources), Clusters (edge compute), Hubs (intermediate processing/coordination), and optionally a Nexus (global oversight). This hierarchical architecture forms an AI-driven orchestration platform comprising components of an Integration layer for standardized data handling (potentially spanning Nodes, Clusters, and Hubs), an Intelligence Layer hosting modular functional services including diverse agents and models (primarily at the Hub and Nexus tiers), and an Interface Layer for multi-modal user interaction (primarily at the Hub tier).

A central Hub acts as a domain coordination point, hosting Orchestration Agents, a Surrogate Factory (using a Master Mechanistic Model and self-generated synthetic tasks to train Mwms), data ingestion layers, communication brokers, knowledge access modules, and User Interaction Agents. These interaction agents include Interface Routing Agents directing communication to appropriate channels (dashboards, reports, mobile, natural language interfaces) and Request/Response Processing Agents that interpret user inputs (especially natural language queries), coordinate with Orchestration Agents to gather data or run analyses, and generate responses (text summaries, figures, reports). The cognitive logic within these agents, particularly the Request/Response Processing and Orchestration Agents, can be implemented using various paradigms, including but not limited to Large Language Models (LLMs) for natural language understanding, reasoning, and response generation, structured decision trees for rule-based processing, all of which may be incorporated into more complex reasoning frameworks such as ReAct (Reasoning and Acting) paradigms for dynamic interaction and task execution. These agents are capable of strictly organizing and managing workflows based on the interpreted requests. The Intelligence layer, hosting microservices at the Hub and Nexus tiers, provides the fabric for these agents and services.

Hierarchical orchestration first decomposes each user or system request into task goals (Mgoal). The cognitive logic determines the optimal allocation of these goals by dispatching them to the most suitable Agent-Packages (APs) by consulting both their Connection Memory (Mmem) and live Emotion Tensors (Memo). This includes dynamically selecting between heterogenous World Models (Mwms), such as emulations or mechanistic models, based on task requirements, performance characteristics, and the spatial and temporal context of the data. This orchestration leverages Memo, including exploration signals, to sample under-explored state spaces. Routing decisions are quantitative: an AP whose Memo shows low rolling-RMSE, modest CPU load, and good data quality is favoured over a congested or drifting peer. Communication between system components, including task directives, interim results, and Memo updates, is facilitated through a standardized semantic envelope. This envelope is defined by protocols or APIs, which may include, but are not limited to, the Model-Context Protocol (MCP) for hub-facing links and a lighter Agent-to-Agent (A2A) schema for direct peer hops. This protocol-agnostic approach ensures that the orchestration layer parses messages identically regardless of the underlying transport mechanism, which could ride on gRPC/TLS, MQTT, DDS-XRCE, or other low-bandwidth mesh protocols. APs execute the assigned workloads at their resident tier (edge Cluster, Hub, or Nexus), compute a local reward (Mrew) derived from measurable operational KPIs, and return both outputs and refreshed Memo. If the Memo crosses a health threshold, adaptive logic is triggered automatically: the task may be re-routed to a healthier AP, an alert raised, or a prioritized retraining job queued in the Surrogate Factory. This Memo-driven control loop, unified by the standardized semantic envelope, cuts prediction latency, elevates model accuracy, and sustains resilience even in constrained network conditions.

The embedding of Surrogate World-Models (Mwm) inside every Agent-Package (AP) provides significant non-obvious advantages, including execution without code rewrites across diverse compute environments (using quantized models), hot-swap portability, mechanistic interpretability for foresight (via symbolic hooks), embedded “mental models” for local planning (Monte-Carlo rollouts), goal-directed behavior (local gradient search), and on-line adaptation (lightweight fine-tuning). APs maintain a persistent experience buffer for continuous, stream-based learning, allowing for small on-device updates. These Mwms can be implemented as emulations, providing high computational speed essential for real-time applications.

At the optional Nexus level, a Supervisory Trio (Global Orchestrator, Creation Agent, Governance Agent) provides oversight. The Governance Agent manages a token-based economy to account for resource contribution and usage across the system. \This includes incentivizing the sharing of federated policy updates between Hubs and can hot-patch reward coefficients based on high-level feedback.

This creates a tight loop with the Creation Agent: when a new AP or workflow is created, its cost/ID is registered in the ledger, and Governance debits/credits tokens at runtime based on actual usage. Hubs can contribute resources (e.g., validated Mwms, workflow templates) to the Nexus and earn tokens based on the measured usage of these contributions by other Hubs, fostering collaboration and efficient resource sharing. This token economy reduces cross-hub compute collisions and incentivizes contribution.

The system connects to multi-modal front-ends, providing operators with unified visualization, analysis tools, alerts, and decision support, accessible through various interfaces including natural language queries processed using LLMs at the Hub. The tiered structure of the Connection Memory (Mmem), including spatial and temporal context, facilitates multi-scale model mediation, reducing integration engineering hours significantly.

Technical effects include significant reductions in prediction latency through the use of computationally efficient emulations, improved model accuracy and robustness through continuous feedback-driven calibration, reduced integration engineering effort via tiered memory mediation and spatial context, and enhanced collaboration through formalized resource accounting. The system enables APs to autonomously learn and optimize control policies that minimize real-world cost functions. The system enables comprehensive water infrastructure management across wastewater treatment, stormwater, distribution networks, and multi-scale environmental/energy modeling, integrating data and models across diverse spatial and temporal scales.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates the internal components of an Agent-Package (AP), showcasing its core innovative element: a tightly integrated tri-tensor core comprising the physics-surrogate World Model (Mwm) for rapid localized prediction, the contextual Connection Memory (Mmem) for storing capabilities and relationships, and the multi-dimensional Emotion Tensor (Memo) quantifying operational health and performance. The figure also shows other key components such as Cognitive Agent Logic, Goal/Reward Logic, Communication Interface, Packaged Tools, and External Event Client, emphasizing how the tri-tensor core enables adaptive edge cognition.

FIG. 2 is a system architecture overview illustrating the novel hierarchical deployment layers of the Hierarchical Digital-Twin System 1, specifically detailing the function of Nodes as data sources, Clusters enabling edge computation and local Agent-Package (AP) deployment, the Hub as a domain coordination and orchestration center, and the optional Nexus providing global oversight and governance. The figure depicts the distribution and interaction of Agent-Packages across these layers, highlighting the flow of data and control signals via communication pathways.

FIG. 3 illustrates the continuous, feedback-driven Surrogate Factory workflow, showcasing the automated process for generating, training, validating, packaging, and deploying computationally efficient physics-surrogate World Models (Mwms). The figure details the inputs to the factory, including the Master Mechanistic Model (MMM) as ground truth, observational/training data, and crucial operational feedback streams such as prediction residuals (Residual feedback loop) and Emotion Tensor (Memo) metrics (Memo feedback loop) from deployed Agent-Packages (APs). It highlights how Memo signals prioritize retraining and model improvement efforts.

FIG. 4 shows the structured and hierarchical nature of the Connection Memory (Mmem), illustrating its tiered organization from Task Connection Memory and Experience Memory within individual APs, through Cluster Connection Memory, Hub-level memories including Interface Connection Memory, Domain Connection Memory, and Policy/Reward Memory, up to Cross-Domain Connection Memory and System Connection Memory at the Nexus. The figure depicts the types of contextual information stored at each level and the relationships between these memory structures, emphasizing how this organization facilitates intelligent task planning, resource discovery, and particularly, efficient multi-scale model mediation.

FIG. 5 illustrates the composition and dynamic usage of the Emotion Tensor (Memo), depicting its multi-dimensional structure with key quantitative metrics (e.g., Accuracy, Load, Data Quality, etc.). The figure shows how Memo values are calculated, how predefined Thresholds are applied, and most importantly, how deviations from these thresholds automatically trigger specific Adaptive Actions, such as alerting operators, requesting model retraining, initiating AP migration, or re-allocating tasks, forming a crucial part of the system's autonomous control loop.

FIG. 6 shows a representative multi-scale model interaction example, illustrating how the Hierarchical Digital-Twin System seamlessly integrates and mediates between models operating at vastly different spatial scales and temporal steps (e.g., a Climate Model AP, Watershed Model AP, Collection System Model AP, Treatment Plant Model AP). The figure demonstrates how the hierarchical Connection Memory (Mmem) facilitates the discovery of compatible models and the application of necessary Data Transformation Packets/Functions (like unit or scale conversions) to enable comprehensive cross-scale analysis and predictive foresight without requiring bespoke integration code.

FIG. 7 provides a detailed view of the Hub architecture, depicting its central role and key functional components hosted on the Hub Server. The figure shows the Orchestration Agents managing task distribution, the User Interaction Agents handling multi-modal user interfaces including natural language processing, the Surrogate Factory for Mwm management, the Data Ingestion Layer for multi-source data fusion, Knowledge Access Modules, Communication Brokers, and their interconnections, highlighting the Hub's role as the domain's operational nerve center managing Hub Deployed APs.

FIG. 8 illustrates the concept of emulation by showing the possible relationships between a Host System (emulator) and a Guest System (emulated). The Host can be Software or Hardware, mimicking the behavior of the Guest, which can also be Software (e.g., a model) or Hardware (e.g., a sensor). This matrix covers the four fundamental emulation pairings.

FIG. 9 provides an exemplary application of emulation, depicting a Host system (Emulation) mimicking a Guest system representing a physical bioreactor process potentially modeled by mechanistic software and incorporating hardware sensor data. The Host Emulation takes similar inputs (e.g., Influent) and produces outputs (e.g., Effluent) that mimic the Guest's behavior efficiently.

FIG. 10 illustrates an exemplary workflow for training an emulation model. The process may use a Mechanistic Model to generate Input and Output Datasets, potentially supplemented by Observed Data, which are used in an Emulator Training step to create the Emulator Model.

FIG. 11 depicts the integration of models in a longitudinal configuration. It contrasts a Mechanistic Model Chain composed of mechanistic segments representing Infrastructure Process Units with a Mixed Emulation Model Chain where some segments are replaced by Emulated Components (Em) to improve speed and integration.

FIG. 12 illustrates a spatially-aware digital twin concept using a 3D Cellular Twin Representation of a system volume discretized into Coordinate Point/Cells within a 3D Space. Each cell can be represented by Mechanistic Coordinate Units, Emulation Units (Em), or an aggregated Emulated Cell, progressing through Time Steps.

FIG. 13 illustrates the workflow of integrating diverse data sources (Soft Sensors, Hard Sensors, IoT, APIs, Lab data) associated with spatial Coordinates within an Integrated Environmental System into the Integrated Digital Twin Emulation Model. The Multi-Agent Orchestration Module interacts with the twin, potentially triggering Control Actions.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below. Embodiments of the present invention will be described below in detail with reference to the accompanying drawings.

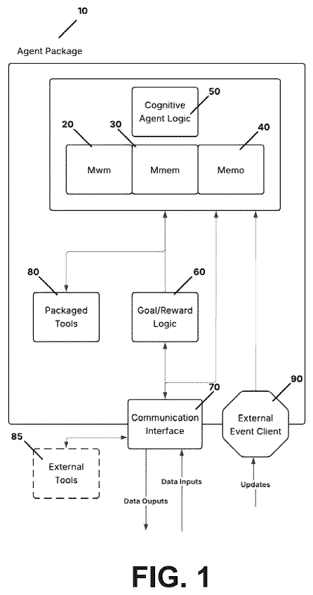

Referring now to FIG. 1, the Agent-Package (AP) 10 is a core innovative element of the present invention. The AP 10 serves as a portable, deployable software unit designed for localized monitoring, prediction, analysis, autonomous learning, and status reporting within a hierarchical system. Each AP 10 can be deployed at various levels of the system hierarchy, enabling flexible and adaptive operation across energy/environment/water infrastructure environments. The AP 10 comprises a novel integrated core and associated logic, representing an exemplary embodiment of the system's distributed intelligence. This integrated core consists of at least one, and typically several exemplary key components that are tightly coupled and mutually influential.

In an exemplary embodiment, these components include:

The first component is a World Model (Mwm) 20, which is a physics-surrogate model that provides a computationally efficient approximation of complex physical, chemical, or biological processes relevant to energy/environment/water infrastructure. This enables rapid local prediction and simulation as well as supporting planning and scenario evaluation with minimal computational resources. The Mwm 20 can take various forms, including Neural Operators, Physics-Informed Neural Networks (PINNs), or other emulators derived from high-fidelity models, as will be further described below.

The second component of this integrated core is a Connection Memory (Mmem) 30, which is a contextual memory store that maintains information about the agent's capabilities, available tools, data sources, communication pathways 170, and relationships with other agents and system components. The Mmem 30 provides the necessary context for intelligent decision-making, task planning, learning, and action selection. It is organized in a hierarchical structure corresponding to the system's layers, with different types of memory serving different functions.

The third component of the integrated core is an Emotion Tensor (Memo) 40, which is a multi-dimensional metric that quantifies the AP's current operational status, performance, and health trends. Dimensions of this tensor include metrics such as model accuracy, computational load, data quality, latency, communication health, available resources, and security status, and can be extended to include signals for learning and adaptation such as exploration bonuses or value estimates. The Memo 40 serves as a continuous, quantitative signal for orchestration routing and adaptation priorities.

In addition to the integrated core components, the AP 10 includes Cognitive Agent Logic 50, which consists of processing routines that handle inputs, interact with the core (Mwm, Mmem, Memo), and make local decisions. This component may include local inferencing capabilities through lightweight language models or joint-embedding predictive architectures. The AP 10 also incorporates Goal/Reward Logic 60, which includes specialized routines that interpret goals (Mgoal) received from higher-level orchestration agents 210 and compute rewards (Mrew) based on execution outcomes. Rewards may be computed from any measurable operational KPI, alone or in learned combinations tuned by high-level policy. This enables the AP 10 to evaluate its performance relative to assigned objectives and learn improved control policies.

For communication purposes, the AP 10 implements a Communication Interface 70 that handles messaging and data exchange with other agents and system components, implementing standardized protocols for reliable and secure communication. The AP 10 further includes Packaged Tools 80, which are a collection of self-contained utilities used by the agent logic to perform specific tasks or transformations relevant to its domain, and an External Event Client 90, which is a specialized component that subscribes to relevant data streams or event triggers from external sources, enabling the AP 10 to stay informed about changes in its operational environment.

The AP 10 enables autonomous local execution, analysis, prediction, status reporting, and adaptive control. The integrated core provides a unique capability referred to as “adaptive edge cognition,” which represents a significant advancement over prior art systems. This adaptive edge cognition allows the AP 10 to select relevant tools based on contextual information stored in its Mmem 30. For instance, when processing a request to predict effluent quality, the AP 10 can determine which analytical models are appropriate based on available data sources and the specific parameters of interest without requiring explicit instructions for each scenario.

Furthermore, the AP 10 can modify its behavior or adjust the confidence levels of its predictions by referencing its own Memo 40. For example, when the Memo 40 indicates poor data quality (e.g., missing sensor readings or values outside expected ranges), the AP 10 can automatically down-regulate its prediction confidence rather than producing potentially misleading results. The integration of context (Mmem) and health state (Memo) allows the AP (10) to make intelligent decisions about when to escalate goals or tasks to higher levels of the hierarchy, or how to adjust local control actions to optimize a defined reward signal. For instance, if a local prediction task requires data that is unavailable or if computational resources are insufficient (as indicated by the Memo), the AP 10 can efficiently escalate the task with complete provenance information.

Additionally, the AP 10 can adapt its operation based on changes in its environment or internal state. For example, if network connectivity deteriorates or computational load increases, the AP 10 can adjust its processing priorities or communication patterns accordingly. This adaptive edge cognition eliminates the need for constant round-trips to a central scheduler for basic adaptive behavior or control adjustments, enabling more efficient and resilient operation even in environments with limited connectivity or high latency.

The co-residence and mutual influence of the exemplary components (Mwm, Mmem, Memo) within a single portable unit forms a key aspect of the invention's novelty. Prior art systems typically lack this integrated approach, where predictive models, contextual memory, and health/learning metrics are tightly coupled and mutually informing. This integration enables a level of local intelligence and adaptation that significantly enhances the system's ability to provide timely and accurate insights, autonomously learn effective control strategies, and manage energy/environment/water infrastructure effectively.

Referring now to FIG. 1, the World Model (Mwm) 20 component of the Agent-Package 10 is described in detail. The Mwm 20 serves a crucial purpose within the invention by providing a computationally efficient approximation of complex physical, chemical, or biological processes relevant to environmental/energy/water infrastructure. This enables rapid local prediction and simulation, and importantly, supports on-device planning and the learning of adaptive control policies via model-based reinforcement learning approaches. This capability is essential for time-sensitive applications where traditional high-fidelity models would introduce unacceptable latency, and for enabling Agent-Packages 10 to operate as self-improving control loops. Continuous streams of experience, comprising sensor observations paired with agent actions and system responses, feed into the Mwm's 20 learning processes, allowing for micro-updates after every inference cycle.

The Mwm 20 can be implemented using various machine learning or reduced-order modeling techniques. These include exemplary embodiments such as Graph/Latent Neural Operators, Fourier Neural Operators (FNO-v2), Diffusion Surrogates, differentiable lattice-Boltzmann solvers, foundation-model adapters fine-tuned on water OT data, and simplified versions of underlying mechanistic ODEs/PDEs, or other data-driven models trained as computationally efficient emulators of high-fidelity models or the physical system itself, as will be further described below. Emerging NeuralODE-PINO hybrids can also be employed, particularly for stiff reaction-transport systems.

The Cognitive Agent Logic 50 within the AP 10 plays a critical role in preparing and “wrangling” the necessary inputs for the Mwm 20. Based on the Mgoal received from orchestration and contextual information stored in the Mmem (which maps available data sources, formats, and relationships) 30, the Cognitive Agent 50 aggregates data from various sources, including real-time sensor feeds from sensor nodes 500, historical records, external forecasts (potentially from other agents), and system state variables. For specific tasks such as simulation, optimization, or scenario analysis, the Cognitive Agent 50 can selectively modify or generate synthetic inputs for the Mwm 20 runs, allowing the AP 10 to explore hypothetical conditions or evaluate alternative operational strategies locally. This is facilitated by the addition of a local replay/experience buffer (integrated within or accessible via Mmem.exp_buffer) 420, enabling the Cognitive Agent 50 to craft synthetic rollouts by stepping the Mwm 20 forward and to store high-TD-error events for learning and prioritized memory-based updates. Furthermore, the system incorporates built-in unit and scale auto-conversion using mechanisms such as an ONNX Runtime-Graph Transform pass, simplifying input preparation. This input preparation and manipulation capability highlights the inter-agent connectivity and data flow, often coordinated by the Hub-level orchestration that directs which data streams are relevant for a given task and AP.

The World Model (Mwm) 20 component, as described above, can be specifically implemented as a computationally efficient “emulation.” This subsection elaborates on the concept and implementation of such emulations within the system.

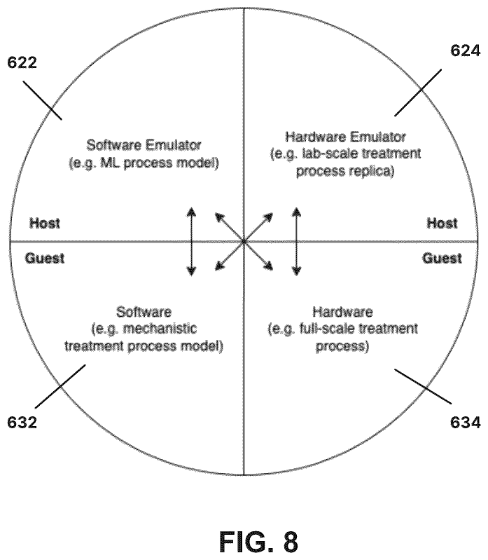

An emulation, as used herein, refers to a software or hardware system configured to mimic the behavior of a “guest” system, apparatus, or method. The guest can be a physical process, a piece of hardware (like a sensor), or another software system (like a complex mechanistic model). This allows a “host” system (the emulation) to operate or run software designed for the guest, providing a computationally efficient or accessible representation of the guest's behavior. Exemplary host/guest pairings include a software emulating hardware, a software emulating another software, a hardware emulating hardware, or a hardware emulating software. (See FIG. 8).

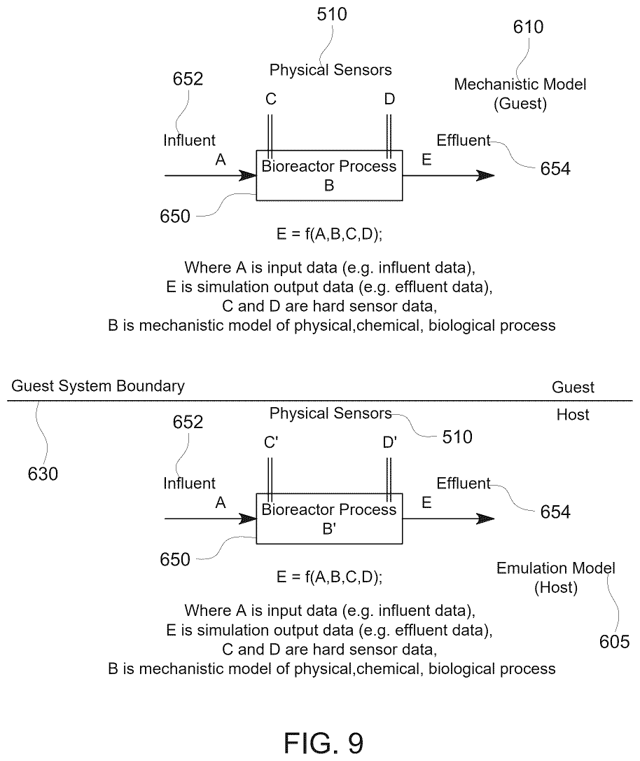

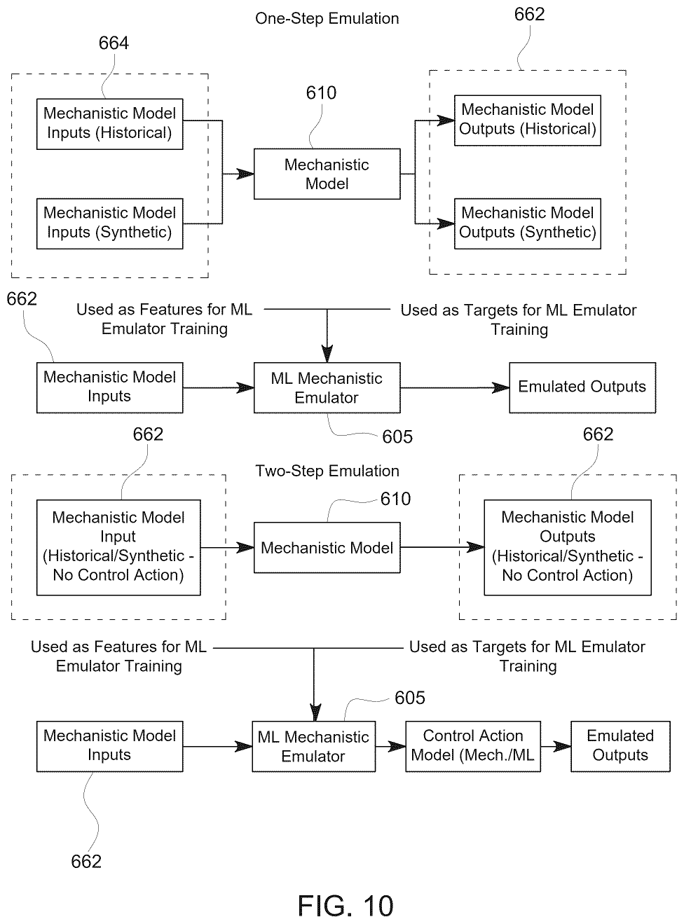

The generation of an emulation typically involves training a data-driven model to mimic the behavior of a mechanistic model 610 or a physical system based on observed data. This process can occur in one or multiple steps. In a multi-step process (see FIG. 10), a mechanistic model 610 may first generate input and output datasets 662 (historical or synthetic). These datasets are then used to train a data-driven model (the emulator), using the inputs as features and the outputs as targets. Feature compression or selection may be applied to ensure accuracy and efficiency. Observed data directly from sensors 510 or processes can also be included as features or targets to improve the emulator's accuracy, potentially surpassing that of the mechanistic model 610 alone. The outcome is a parallel system that can generate simulations significantly faster than mechanistic models 610, typically ranging from 1.1 times to 100,000 times faster, depending on the complexity of the guest and the simulation period. This process is managed by the Surrogate Factory 230, which generates, trains, validates, and packages these emulators for deployment, deciding which form of Mwm (mechanistic, emulator, or hybrid) 20 to embed in an AP 10 based on factors like required speed, accuracy (informed by Memo), and computational resources at the target deployment tier. (See FIG. 9 for an exemplary host-guest bioreactor simulation).

Specifically, FIG. 9 provides an exemplary application of emulation, depicting a Host system (Emulation) mimicking a Guest system representing a physical bioreactor process 650 potentially modeled by mechanistic software and incorporating hardware sensor data. The Host Emulation takes similar inputs (e.g., Influent 652) and produces outputs (e.g., Effluent 654) that mimic the Guest's behavior efficiently.

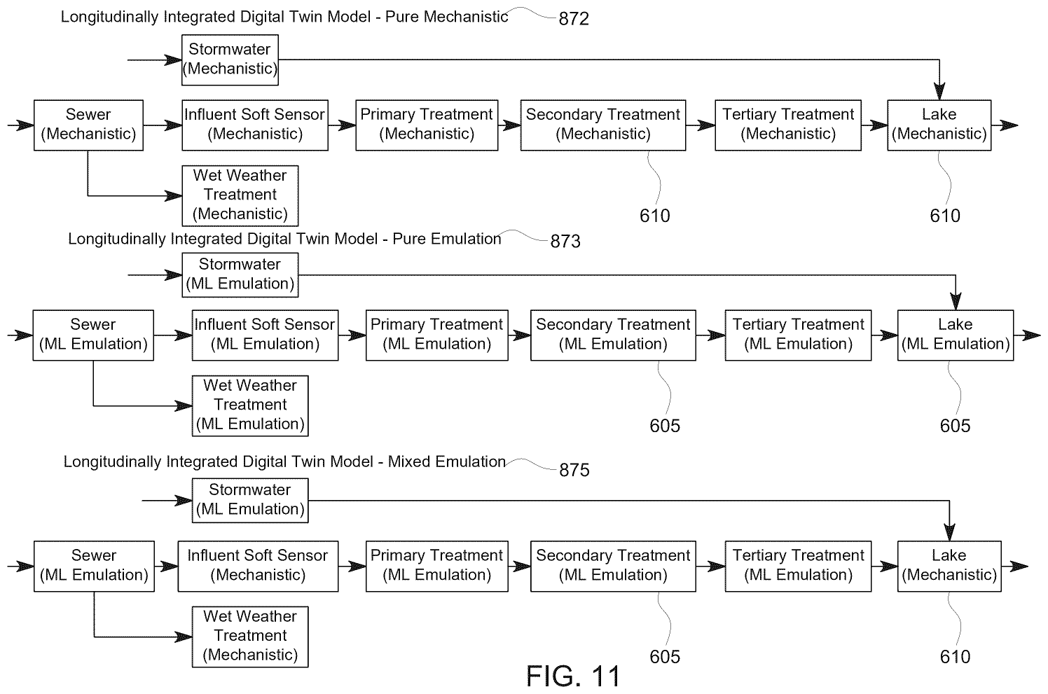

Emulations are particularly valuable for integrating models in complex, interconnected systems, such as longitudinal configurations representing integrated infrastructure or watershed models. They can bridge gaps between models operating at different temporal or spatial scales and with incompatible interfaces, overcoming the challenges associated with directly linking disparate mechanistic models 610 (See FIG. 11). By emulating complex or slow components, the system can create mixed mechanistic 610/emulation models 605 or even purely emulated setups, dramatically reducing computational burdens and increasing simulation speeds. This adaptability facilitates seamless integration of processes and environments, even those lacking current mechanistic models 610 or where such models are computationally prohibitive. Emulations can also amalgamate multiple processes or distinct models/software into a single step, further optimizing integration and potentially obviating the need for complex, brittle application programming interfaces (APIs) between different software packages. This approach allows the system to model every point or region in space and time within an integrated environmental system 820, linking models and data to specific spatial (x, y, z) coordinates and temporal (t) attributes, which is further described below.

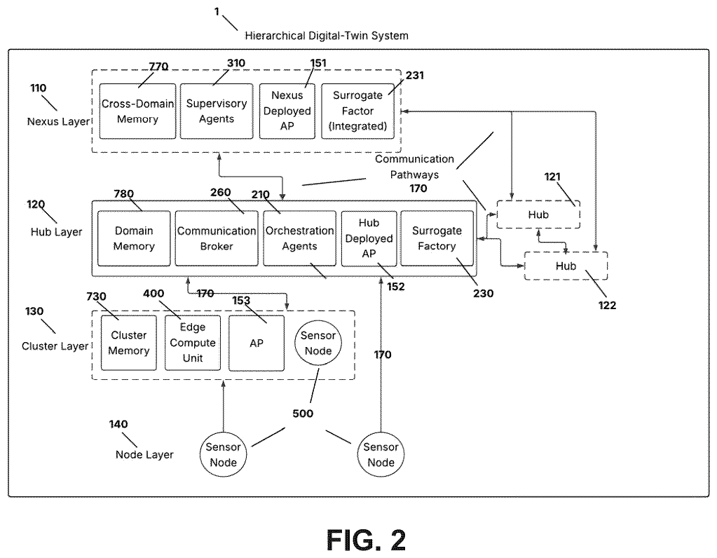

The generation of these Mwm 20 components occurs within a specialized environment referred to as the Surrogate Factory 230, which is typically located at the Hub level of the system hierarchy, as depicted in FIG. 2. The Surrogate Factory 230 systematically generates, trains, validates, and packages Mwms 20 for deployment. This process relies on a Master Mechanistic Model 235—a high-fidelity, physics-based digital twin that serves as the ground truth for training purposes—as well as observational data collected from the operational environment. The Master Mechanistic Model 235 is continually executed to maintain a current, high-fidelity representation of the system state and calibrated parameters. This current state information is passed to the Surrogate Factory 230 and used to ensure that the Mwms 20 are trained and calibrated against the most up-to-date understanding of the physical system. The Master Mechanistic Model 235 incorporates comprehensive representations of the relevant physical, chemical, and biological processes, such as hydraulic flows, settling behaviors, chemical reactions, and biological kinetics, depending on the specific energy/environment/water infrastructure domain being modeled. The Factory now supports federated fine-tuning, where edge APs 10 can send aggregated gradient deltas or low-rank adapter (LoRA) weights to the Factory, respecting data-sovereignty regulations by avoiding direct transfer of raw data. Critically, the Factory also supports self-generated counter-scenario augmentation, creating synthetic datasets for robustness training on rare or extreme events (such as extreme rainfall combined with asset failure) using techniques like diffusion models, ensuring Mwms 20 are trained on challenging conditions outside historical envelopes.

The calibration and updating of Mwms 20 from the Master Model and operational data proceeds through an automated process managed by the Surrogate Factory 230. This process is informed by feedback, including prediction residuals and the Memo signals from deployed APs. The Surrogate Factory 230 itself may maintain its own internal monitoring or Memo-like status to track the performance and efficiency of its training processes. When changes in system state, such as newly calibrated kinetic parameters from the Master Model, occur, or when operational feedback indicates model drift, this can trigger a retraining event in the Surrogate Factory 230. Alternatively, depending on the design and feature set of the specific Mwm 20, certain state changes or parameters might be handled directly as inputs to the trained surrogate model without requiring immediate retraining, providing flexibility in how the system adapts to evolving conditions. Importantly, the Surrogate Factory 230 continuously refines and improves the Mwms 20 based on feedback received from deployed APs. This feedback includes prediction residuals (the differences between predicted and observed values) as well as the Memo status of the APs, which reflects their operational health and prediction accuracy. This creates a closed-loop learning system where surrogates are continuously calibrated and retrained based on real-world performance data. The Factory prioritizes the retraining of models that demonstrate higher error rates, as indicated by the Memo metrics, ensuring that computational resources for retraining are directed where they are most needed. In addition to Factory-driven updates, lightweight Elastic Weight Consolidation or RePTile-style meta-updates can run on-device between Factory cycles, gated by Memo.explore>τ (where τ is an exploration threshold), enabling rapid local adaptation.

Once trained and validated, the Mwms 20 are packaged and embedded within APs 10 before deployment to Clusters or Hubs. This packaging process includes the creation of a self-describing manifest that contains schema information, units, input-range hashes, and version identifiers. This manifest allows receiving systems to verify compatibility and provenance before loading the model. Packaging targets include WebAssembly and WebGPU for browser/UAV dashboards, and optional FPGA bitstreams can be included in the OCI manifest for specialized hardware acceleration.

The embedding of Mwms 20 inside every Agent-Package (AP) 10 provides several non-obvious advantages that significantly enhance the system's capabilities and efficiency.

First, it enables edge-scale execution without code rewrites. Mwms 20 are exported in lightweight formats such as ONNX or TorchScript graphs with quantized weights, typically resulting in small file sizes (less than 15 MB). This allows direct, efficient inference on low-power edge CPUs such as ARM Cortex-A53 or small dedicated accelerators such as Tensor Processing Units (TPUs) commonly found in sensor hubs. This capability eliminates the need for recompilation or constant cloud dependency for basic predictions, allowing the AP 10 to function effectively even in environments with limited connectivity or bandwidth.

Another advantage is hot-swap portability. The small size and standardized format of the Mwm 20 allow it to be streamed to a new Cluster or compute instance in seconds over low-bandwidth networks such as MQTT. This enables live migration of predictive capabilities when the AP's Memo flags issues like thermal throttling or resource contention, ensuring continuous operation despite changing hardware conditions.

The Mwms 20 also provide mechanistic interpretability for foresight. Unlike purely black-box models, these surrogates can store symbolic hooks or latent representations learned from the underlying master ODE/PDE model, such as Jacobian sparsity maps or sensitivity matrices. This allows orchestration agents 210 to query the AP's Mwm 20 for insights such as “what variable drives the effluent NH₄ spike?” and receive interpretable causal sensitivity scores, providing valuable foresight that black-box CNNs or simple regression models cannot supply.

A particularly valuable feature is that the Mwm 20 acts as an embedded “mental model” for local planning. The AP 10 can run rapid Monte-Carlo rollouts or simulations within the surrogate to evaluate the potential outcomes of alternative local actions, such as adjusting a blower setpoint or opening a valve, before committing to a decision. This provides sub-second foresight and enables proactive local planning without requiring a round-trip to the hub for simulation, significantly enhancing real-time decision-making capabilities. This embedded capability supports look-ahead planning, where Mwm.imagine(action_seq) returns predicted KPI trajectories and associated rewards, enabling on-device Model Predictive Control (MPC) or Monte Carlo Tree Search (MCTS) algorithms.

A significant advantage for autonomous learning is the inclusion of a grounded-reward head as an extra output of the Mwm 20. This head is trained to estimate cumulative operational reward signals derived directly from measurable KPIs (such as energy consumption, nutrient violation penalties, or pump starts), moving beyond simple prediction error to align learning with real-world objectives.

The Mwm 20 also contributes to the system's exploration capabilities. By providing prediction uncertainty or error variance, the Mwm's 20 output can feed into an exploration bonus channel (Memo.explore) within the Emotion Tensor 40, driving curiosity-based data collection and encouraging the AP 10 to sample under-explored regions of the state space.

The Mwm 20 further enables goal-directed behavior. If the Mwm 20 exposes a differentiable loss function or can be used within an optimization loop, the AP can perform local gradient search or other optimization techniques to adjust control suggestions or parameters to minimize the error relative to the Mgoal defined by the orchestrator. This capability extends to optimizing control set-points by running algorithms such as Cross-Entropy Method (CEM), gradient descent, or policy-gradient methods directly inside the Mwm 20, typically achieving optimized control suggestions in less than 500 ms. This effectively turns the local prediction capability into on-device optimization towards a specific objective, allowing APs 10 to autonomously work toward defined goals even when temporarily disconnected from the central hub.

On-line adaptation represents another significant advantage. The AP 10 can apply lightweight online learning techniques, such as Elastic Weight Consolidation (EWC) style updates, to the Mwm 20 when its Memo's accuracy channel indicates significant drift (for example, greater than 8% rolling-window error). This fine-tunes only specific layers, such as the last adapter layer, to remove bias caused by concept drift, allowing the model to adapt to changing conditions in minutes without increasing model size or requiring full retraining at the factory. This is often implemented via an optional tiny continual-learning adapter (<1 MB) that can be swapped via hot-patch over MQTT and supports replay-buffer distillation to prevent catastrophic forgetting of previously learned knowledge. This adaptation capability is crucial in energy/environment/water infrastructure environments, where conditions can change rapidly due to environmental factors, process modifications, or equipment aging.

Finally, the Mwm 20 architecture supports configurable multi-persona models. A single Mwm 20 binary can contain switchable “persona heads” or output layers optimized for different predictive or control tasks, such as a hydraulic head, a nutrient head, and an energy consumption head. Orchestration can toggle the active head via a small protobuf command, allowing one AP 10 to re-configure its predictive or control focus dynamically based on the current task without requiring redeployment of a different model. This is enabled by a schema-driven dynamic heads concept, where the Hub can ship a new YAML descriptor, and the AP 10 auto-generates a matching output head with low-rank initialization (LoRA), allowing for flexible model adaptation without full retraining. This flexibility significantly reduces deployment complexity and resource requirements while maintaining specialized capabilities for diverse aspects of energy/environment/water infrastructure operation.

Through these features and capabilities, the Mwm 20 component provides a powerful, flexible, and efficient foundation for the AP's predictive, analytical, planning, and autonomous control functions, enabling sophisticated local intelligence with minimal computational overhead and exceptional adaptability to changing conditions. These upgrades move the Mwm 20 from a static emulator to a self-refining, planning world-model, enabling agents to learn and improve continuously from interaction with their environment.

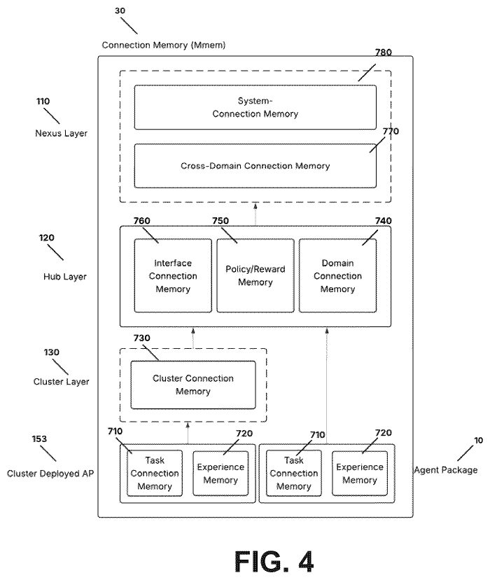

Referring now to FIG. 4, the Connection Memory (Mmem) 700 component of the Agent-Package 10 is described in detail. The Mmem 700 serves a fundamental purpose within the invention by providing the agent hierarchy with the necessary context about capabilities, connections, data sources, relationships, and operational experience to enable intelligent decision-making, task planning, communication, and continuous learning. This contextual awareness is essential for effective operation in complex, distributed water/energy/environment infrastructure environments where numerous interrelated processes and data sources must be coordinated. In certain embodiments, the Mmem 700 also serves as a ground-truth provenance ledger, where every edge can carry a hash or identifier linking back to the originating data stream, model version, or agent that established the connection, thereby enhancing auditability and traceability.

The Mmem 700 is organized into a hierarchical and typed structure that corresponds to the system's overall architecture. This tiered organization allows for efficient storage and retrieval of contextual information at the appropriate level of granularity and scope.

In an exemplary embodiment, the hierarchical structure includes the following memory types:

At the lowest level, the Task Connection Memory 710 resides within an individual AP 10 and maps the specifics of the current task, required inputs/outputs, and local tools available to the agent. This memory enables the AP 10 to understand its immediate operational context and the resources at its disposal for completing assigned tasks.

In certain embodiments, an Experience Memory 720 also resides inside each AP. This memory comprises a prioritized ring buffer or reservoir, indexed by factors such as Temporal Difference (TD) error or novelty. It stores streams of recent operational experience, including environmental observations, agent actions, and reward stubs. This Experience Memory 720 feeds on-device policy updates and model refinement processes, supporting lifelong learning.

At the next level, the Cluster Connection Memory 730 maps connections, data flows, and agent relationships within a specific Cluster. This memory spans multiple APs 10 operating within the same local environment, such as a wastewater treatment plant subsection or a distributed sensor network monitoring a specific geographic area. The Cluster Connection Memory 730 allows APs 10 to coordinate their activities and share resources efficiently within their local domain.

Moving up the hierarchy, the Domain Connection Memory 740 operates at the Hub level and is used by Orchestration Agents 210 to map connections, dependencies, and domain-specific knowledge across different Clusters and Hub-level components within a particular water infrastructure type (such as wastewater treatment, water distribution, or stormwater management). This can apply broadly to energy and environment infrastructure. This memory enables the coordinated execution of complex workflows that span multiple subsystems or geographical locations, ensuring that tasks are appropriately scheduled and resources efficiently allocated across the broader system, while leveraging domain-specific connection patterns, integration templates, and common workflows. This specialized memory allows the system to leverage domain-specific knowledge and best practices when analyzing data and making predictions, enhancing the relevance and accuracy of its outputs.

In certain embodiments, a Policy/Reward Memory 750 resides at the Hub level. This memory maps KPI signals to corresponding reward functions and may store learned policies or policy components. This memory can be edited by the Governance Agent 316 for alignment fixes, enabling high-level policy goals to influence the local reward signals and learning objectives of Agent-Packages 10.

The Interface Connection Memory 760, also residing at the Hub level, is utilized by User Interaction Agents 220, specifically Interface Routing Agents 222 and Request/Response Processing Agents 224. This memory maps communication channels and formats for different user interfaces 900, including dashboards, reports, mobile applications, and natural language interfaces 914. It stores patterns for translating user intent, especially from natural language queries, into relevant agent capabilities, required data sources, and desired output formats, whether text, figures, or structured reports. This translation capability is crucial for making the system accessible to operators with varying levels of technical expertise.

At the highest levels of the hierarchy are the Cross-Domain Connection Memory 770 and System Connection Memory 780. The Cross-Domain Connection Memory 770, residing at the Nexus level, stores connection patterns and integration templates that span multiple domains or Hubs. This facilitates comprehensive analyses that consider interactions between different water infrastructure systems, such as how changes in a watershed affect downstream treatment facilities. The System Connection Memory 780, also at the Nexus level, represents the highest tier and stores overall architectural patterns, global dependencies, and system-wide policies that govern the operation of the entire system.

The Mmem 700 is consulted by APs 10 for local action planning, by Hub-level agents for orchestration and resource management, and by higher-level agents (Orchestration, Interface, Governance, Creation) for task decomposition, routing, resource discovery, policy enforcement, and system evolution. The tiered structure facilitates efficient multi-scale model mediation by storing pointers and unit/scale metadata at each level. This allows orchestration to compose complex chains, for example linking climate models 842 to watershed/airshed/energyshed models 840 to plant models, by simply following graph edges with matching scale tags and associated transformation functions. An energyshed is a geographical area where the power consumed within it is supplied from within that same area and/or from a source(s) that are of interest to that area. Energysheds can include many centralized or decentralized sources and include raw, refined and managed sources of energy (for example from solar, wind, water, chemicals (such as gas, petroleum, nuclear), thermal). An airshed is a geographical area where the movement of air and air pollutants are considered based on geographical features and/or weather patterns. A watershed is a geographic area (including such as an area or ridge of land) that separates waters flowing to different rivers, basins, or seas, or an area or region drained by a river, river system, or other body of water. The ‘shed’ could be continental, national, regional, subregional or local depending on context and sources. These sheds have spatial and temporal scales of varying magnitudes.

This technical effect removes the need for bespoke adapters and significantly reduces integration latency from potentially hours to seconds when a new model or data source is introduced to the system.

The below embodiments for implementation of the Mmem 700 typically utilizes a streaming temporal knowledge-graph technology, such as exemplary embodiments based on Neo4j integrated with Apache Kafka or TigerGraph integrated with Kafka, to efficiently store and query complex relationships and their evolution over time. This database structure allows for the representation of entities (agents, data sources, models, tools, policies, experience data) as nodes and their relationships as edges, with both nodes and edges having properties that describe their characteristics. Updates to the graph can be event-sourced, ensuring that every change is append-only, time-stamped, and associated with provenance, which supports robust rollback capabilities and causal queries. Agents can issue graph queries, for example using the Cypher query language or other graph query languages, to discover capabilities, connections, or relevant historical experience. A query such as “MATCH (me)-[ ]->(tool) WHERE tool.latency<50 ms RETURN tool” allows an agent to identify tools that it can access and that meet specific performance criteria.

The Mmem 700 supports various query patterns that enable sophisticated context-aware operations. For instance, an Orchestration Agent 210 might query the Mmem 700 to identify all APs 10 capable of predicting ammonia levels in a specific region of a treatment plant, considering their current health status and data access permissions. Similarly, a Request/Response Processing Agent 224 might query the Mmem 700 to determine how to translate a natural language query about energy efficiency into a structured workflow involving specific models and data sources. Schema and ontology enhancements are incorporated, referencing standards like W3C SSN/SOSA for sensors 510 and observations, OpenMI for model interfaces, and potentially OPSWMM ontologies for hydraulic assets, which improves interoperability. The system also allows for open-vocabulary capability tags, enabling new AI tools or data sources to auto-register within the graph without requiring rigid schema migration.

In certain embodiments, the Mmem 700 implementation supports the fusion of vector and symbolic representations. Embedding fingerprints (e.g., using FAISS or pgvector extensions) can be stored on nodes representing entities like sensor time series or event signatures to enable efficient similarity search (e.g., “find a pump with a vibration signature like this”). Symbolic edges are maintained for hard constraints and logical relationships, and hybrid queries can combine graph traversal (Cypher) with approximate nearest neighbor (ANN) search for flexible and powerful context retrieval.

The Mmem 700 also incorporates built-in graph reasoning capabilities. For example, edge attributes can hold executable code snippets, such as eBPF-style bytecode or ONNX graph transforms, letting an AP 10 or orchestrator walk the graph and execute data conversions or transformations on the fly as part of a query result. An optional Graph Neural Network (GNN) service (e.g., using GraphSAGE or Graph Attention Networks) can analyze the graph structure to generate link-prediction scores, suggesting potentially unseen couplings or relationships between entities (e.g., inferring a new flow-quality dependency based on graph structure and observed data patterns).

Privacy and tenancy controls are integrated directly into the Mmem 700 structure. Per-edge or per-node visibility classes can define access permissions, and differential-privacy noise masks can be applied to sensitive or regulated data properties. The Governance Agent 316 enforces these token-priced access controls, ensuring data sovereignty and secure collaboration.

The Mmem 700 also implements auto-pruning and summarization mechanisms for lifelong memory management. A periodic “sweep” job can drop stale, low-centrality edges or compress clusters of nodes and edges into summary hyper-edges based on criteria like time since last access or contribution to reward signals, keeping memory size bounded while retaining informative events.

Exemplary query examples enabled by this enhanced Mmem 700 include:

Retrieving a real-time actuation chain with low latency: MATCH p=shortestPath ((src: Sensor)-[: feeds* . . . 5]-> (dst: Actuator)) WHERE ALL(r IN relationships(p) WHERE r.latency<2s) RETURN p

Finding similar events assets based on vector embeddings: CALL vector.knn (‘embedding’, $vec, 10) YIELD node (where ‘vector’ and ‘knn’ are hypothetical plugin functions)

The Mmem 700 architecture includes resilience hooks to support graceful degradation and recovery. For example, on detecting an edge failure (e.g., a sensor going offline), the Orchestrator can automatically trigger a fallback query against the Mmem 700, such as: MATCH (alt)-[: provides]->(param) WHERE distance (alt.location, failed.location)<1 km AND alt.status=‘healthy’ RETURN alt LIMIT 1 to find alternative data sources or capabilities near the failed component.

The tiered structure of the Mmem 700 also facilitates knowledge sharing and reuse across the system. Common patterns, successful workflows, validated integration templates, learned policies, and reward functions can be stored at appropriate levels of the hierarchy and then accessed by multiple components, promoting consistency and reducing redundant development effort. For example, a successful approach to predicting clarifier performance or a learned aeration control policy can be stored in the Domain Connection Memory 740 and then reused across multiple facilities with similar equipment.

A particularly valuable aspect of the Mmem 700 is its ability to adapt and evolve over time. As new components are added to the system, new relationships are discovered, or existing patterns are refined through operational experience, the Mmem 700 is updated to reflect this changing knowledge. This learning process can occur through explicit updates by system administrators or through automated processes that analyze system performance, identify successful patterns, or process streams of new operational experience and learned policies.

The Mmem 700 also plays a crucial role in system resilience and fault tolerance. By maintaining comprehensive knowledge about system capabilities and connections, along with historical experience and learned fallback patterns, the Mmem 700 enables the system to adapt to component failures or communication disruptions by identifying alternative resources or pathways. For example, if a particular sensor 510 becomes unavailable, the Mmem 700 can help identify alternative data sources or inference methods that can provide the needed information through different means, or suggest learned policies that can operate effectively with partial information.

Through its hierarchical structure, flexible streaming temporal knowledge-graph implementation incorporating vector and symbolic fusion, graph reasoning, privacy controls, and auto-pruning, and comprehensive mapping of system capabilities, relationships, operational experience, and learned policies, the Mmem 700 provides the contextual foundation necessary for intelligent, adaptive, continuously learning, and coordinated operation across the distributed water infrastructure management system (also energy and environment infrastructure systems). This contextual awareness significantly enhances the system's ability to deliver timely, relevant, and accurate insights and predictions, support effective planning and control, and improve system resilience, even in complex and changing environments.

A foundational aspect of the Mmem 700 and the overall system architecture is the explicit representation and integration of spatial and temporal context. In an embodiment of the invention, every point within the modeled system, whether representing a physical location in infrastructure or within a natural system (watershed, airshed, energyshed), is assigned a coordinate (x, y, z, t). The two- or three-dimensional spatial coordinate 800 (x, y, z) can represent a cartesian coordinate, a geographic coordinate system, or an arbitrary location defined by one, two, or three values providing an approach for dimensioning the infrastructure or the relevant ‘shed’. The elevation or depth dimension (z) is crucial for integrating hydraulic or pneumatic characteristics. The temporal coordinate (t) 805 anchors the data and model outputs in time. Each point (x, y, z, t) possesses attributes derived from sensors 510 (real or soft) or models, defining its state.

This coordinate-based representation is stored and managed within the system, potentially utilizing a geographic information system (GIS) component integrated with or accessible via the Mmem 700. This allows for storing, querying, and displaying information associated with specific points or streams (water, air, energy) within their spatial and temporal context. Such representation facilitates the calculation of attributes like potential energy based on coordinates or kinetic energy based on mass flows, enabling comprehensive analysis across geographic or infrastructure boundaries. This digital platform can combine any number of watershed, airshed, energyshed, and/or infrastructure elements.

Multiple points or coordinates can be aggregated or converted into a cell, where each cell can also possess attributes. This cellular approach allows for regional calculations or the application of methodologies like cellular automata, considering processes occurring within a cell and exchanges between adjacent cells in two or three dimensions. This coordinate or cell approach enables the assignment of attributes to any point or region in space (air, water, surface, subsurface) and time, providing a granular framework for system modeling.

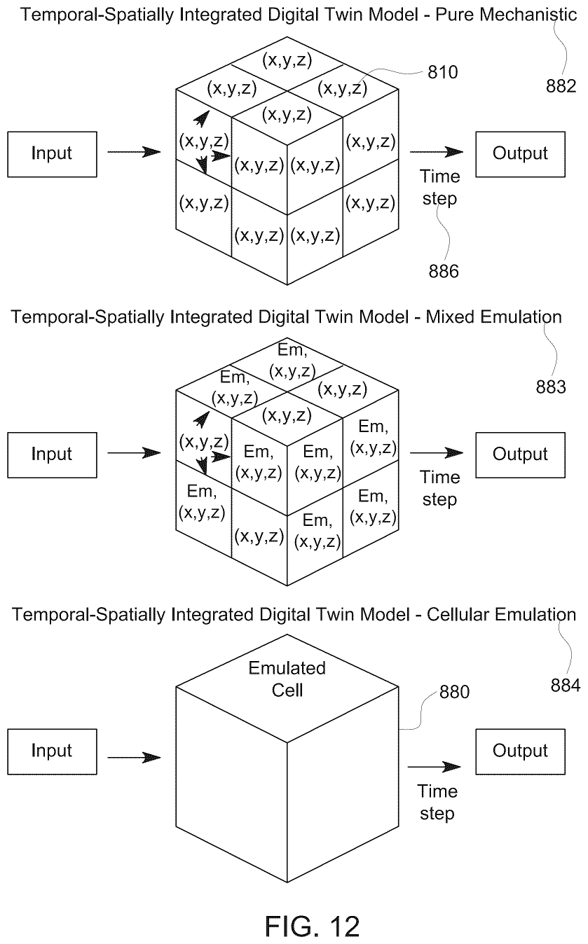

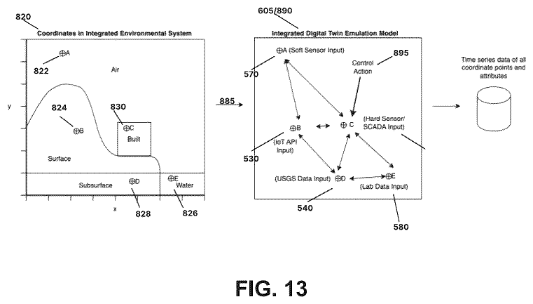

This spatial-temporal framework underpins the system's ability to create a comprehensive digital twin of an integrated environmental system 820, as depicted conceptually in FIG. 12 and FIG. 13. The digital twin can represent the system using purely mechanistic models 610, purely emulation-based models, or a hybrid approach combining both. In the mixed emulation model (see FIG. 12), some processes or regions are represented by mechanistic coordinate units, while others are represented by emulations (Em). Emulations are particularly useful for components where mechanistic behavior is undetermined, computationally prohibitive, or less critical, allowing flexibility in connecting functions across different spatial or temporal scales. For instance, as shown in FIG. 11, emulations can bridge gaps in longitudinally integrated models (e.g., infrastructure chains or watershed models) where linking disparate mechanistic models 610 directly is challenging due to timescale or input/output mismatches, significantly improving simulation speed and integration feasibility.

Specifically, FIG. 11 depicts the integration of models in a longitudinal configuration. It contrasts a Mechanistic Model Chain 872 composed of mechanistic segments representing Infrastructure Process Units 870 with a Mixed Emulation Model Chain 875 where some segments are replaced by Emulated Components (Em) to improve speed and integration.

Further, specifically, FIG. 12 illustrates a spatially-aware digital twin concept using a 3D Cellular Twin Representation 880 of a system volume discretized into Coordinate Point/Cells 810 within a 3D Space 881. Each cell can be represented by Mechanistic Coordinate Units 882, Emulation Units (Em) 883, or an aggregated Emulated Cell 884, progressing through Time Steps 886.

Further, specifically, FIG. 13 illustrates the workflow of integrating diverse data sources (Soft Sensors, Hard Sensors, IoT, APIs, Lab data) associated with spatial Coordinates within an Integrated Environmental System into the Integrated Digital Twin Emulation Model 890. The Multi-Agent Orchestration Module 970 interacts with the twin, potentially triggering Control Actions.

Whether using mechanistic units, emulations, or cells representing aggregated processes, the system models behavior in discrete time steps 886 across the defined three-dimensional space. This approach allows the modeling of every coordinate space or region within the integrated environmental system 820, incorporating data from diverse sources (hard sensors, soft sensors, APIs, lab data) linked to specific coordinates. The Mmem 700 facilitates this by storing the relationships, scales, units, and necessary transformations between different coordinate-based models or data sources, enabling the orchestration layer to dynamically discover and chain compatible components for analysis or simulation across the spatial-temporal domain. FIG. 13 illustrates the conceptual transfer of coordinate-based information into the comprehensive digital twin, which incorporates control actions informed by this spatially and temporally aware model. This integrated spatial-temporal context within Mmem 700 is crucial for enabling holistic analysis, predictive foresight, and effective management of complex, interconnected environmental and infrastructure systems.

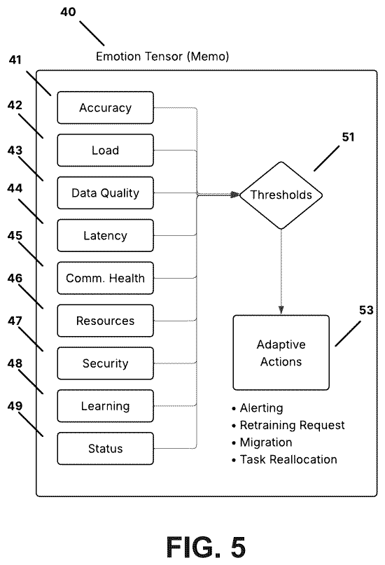

Referring now to FIG. 5, the Emotion Tensor (Memo) 40 component of the Agent-Package 10 is described in detail. The Memo 40 serves a critical purpose within the invention by providing a multi-dimensional, quantitative representation of an AP's or system component's current operational state, health, and performance. This mechanism for introspection and status reporting, which includes crucial signals for autonomous learning and adaptive control, represents a significant advancement over prior art systems, which typically lack sophisticated self-assessment capabilities and the necessary internal metrics for driving intelligent behavior.

The Memo 40 is structured as a multi-dimensional tensor or vector with normalized metrics that comprehensively capture different aspects of operational health and learning state. In an exemplary embodiment, these dimensions include Accuracy, which represents a rolling Root Mean Square Error (RMSE) or other appropriate error metric calculated over the last k predictions compared to ground truth or validated data. This dimension provides insight into the predictive performance of the AP's embedded Mwm 20 and helps identify when model drift or other issues are affecting prediction quality. Another dimension is Load, which aggregates metrics of computational resources used by the AP, potentially including CPU utilization percentage, RAM usage percentage, and I/O wait times. These metrics may be weighted according to their relative importance in the specific deployment context. For example, in an edge device with limited processing power, CPU utilization might receive a higher weight, while in a server environment with ample processing but limited memory, RAM usage might be weighted more heavily. Data Quality represents another crucial dimension of the Memo 40, quantifying the ratio of valid data samples received to expected data ticks, or incorporating other data integrity metrics such as signal-to-noise ratio or compliance with expected ranges. This dimension helps identify issues with sensor performance, communication problems, or other factors that might compromise the reliability of incoming data. The Memo 40 also tracks Latency, measuring the average time taken by the AP 10 to process a request or generate a prediction. This metric is particularly important for time-sensitive applications where delayed responses could impact operational decisions or miss critical events. Communication Health is another dimension that captures the status of network connectivity and message queue health, helping to identify connectivity issues or communication bottlenecks that might affect the AP's ability to exchange information with other system components. Additional dimensions may include Resources, which tracks available local resources such as disk space or battery level on edge devices, and Security, which monitors the status of security checks or anomaly detection mechanisms to identify potential security threats or vulnerabilities.

In certain embodiments, the Memo 40 is extended to include a Value Estimate dimension, which provides a running prediction of the expected long-term grounded reward that the AP 10 anticipates receiving for its current state and potential future actions, as estimated by a value head or function associated with the AP's learning policy; this is crucial for model-based reinforcement learning. A further dimension in certain embodiments is the Exploration Bonus, representing a curiosity or entropy score that quantifies the potential for gaining new, valuable information by exploring less-visited states or taking uncertain actions; this signal drives data collection behaviors aimed at reducing uncertainty and improving the Mwm 20 and learned policies.

In yet other embodiments, an Uncertainty dimension is included, capturing the predictive uncertainty of the Mwm's 20 outputs, for example, using metrics like Monte-Carlo dropout variance, ensemble spread, or quantile regression bounds; this provides insight into the reliability of predictions and feeds into risk-aware routing and decision-making. An Anomaly Score dimension may also be included in some embodiments, providing a measure of how anomalous the current operational state is, potentially calculated as the percentile of the reconstruction error from an auto-encoder watchdog monitoring the AP's inputs and internal states; this assists in detecting unexpected conditions.

Finally, in certain embodiments, an Alignment Flag dimension is present, providing a signal indicating potential divergence between the low-level grounded rewards being optimized by the AP 10 and higher-level operational goals or user feedback; this may be quantified as a distance or discrepancy measure, used to detect potential reward hacking or misaligned objectives.

The Memo 40 is calculated locally and continuously by the AP 10 based on its internal state and observed performance. This calculation typically involves normalizing each metric to a common scale (for example, 0 to 1) and potentially applying transformations to ensure appropriate sensitivity across the full range of possible values. The specific calculation methods may vary based on the deployment context and the particular needs of the water infrastructure environment being monitored (also energy and environment infrastructure systems).

In certain embodiments, the Memo 40 is stored and managed as a time-tagged vector or matrix, where the last N snapshots form a small temporal window. This structure enables higher-level agents or internal logic to efficiently compute trend slopes, detect rates of change, and identify pre-failure indicators for proactive alerts. The Memo 40 structure can also support sparse extension fields, allowing Hubs or the Nexus to push new monitoring channels or metrics to APs 10 dynamically via configuration updates without requiring firmware updates, using flexible serialization formats like ProtoBuf Any or Type-Length-Value (TLV).

The AP 10 emits Memo updates dynamically. In certain embodiments, instead of or in addition to fixed heartbeat intervals, the AP 10 emits Memo “deltas” when the L1 norm (or other suitable norm) of the change in the Memo vector, ∥ΔMemo∥₁, exceeds a predefined threshold ε. This event-driven publishing reduces unnecessary network traffic during stable operation. The Memo updates are efficiently serialized and compressed, for example, using Concise Binary Object Representation (CBOR) combined with lightweight compression algorithms like zstd, to minimize bandwidth consumption.

The Memo calculation is enabled through specific formulas and methods. For Accuracy, the AP 10 typically calculates a rolling RMSE over the last k predictions compared to ground truth or validated data, which can be expressed as:

$$Accuracy = sqrt ( sum ( ( predicted\_i - actual\_i ) \hat{} 2 ) / k )$$

For Load, a weighted sum of resource utilization metrics is often employed:

$$Load = w 1 * CPU \% + w 2 * RAM \% + w 3 * I / O\_wait$$

where w1, w2, and w3 are weights that reflect the relative importance of each resource in the specific deployment context. Data Quality might be calculated as:

$$Data Quality = Valid\_samples \_received / Expected\_samples$$

where the expected number of samples is determined based on the known sampling frequency and the time window being considered. In certain embodiments, new metrics are calculated, such as:

$$explore\_t = beta * sigma \hat{} 2 \_pred$$

which represents a curiosity-driven exploration bonus based on the prediction variance (sigma\hat{ }2_pred) scaled by a factor beta.

$$value\_err \_t = \vert V\_pred - R\_t + k \vert$$

which represents a Temporal Difference (TD) error for value estimation, calculated as the absolute difference between the predicted value (V_pred) and the actual cumulative future reward (R_t+k) observed after k steps. These individual metrics are then normalized and combined into the final Memo tensor:

$$Final Memo = [ {Accuracy}_{norm} , {Load}_{norm} , {DataQual}_{norm} , {Latency}_{norm} , {explore}_{norm} , {value\_err}_{norm} , … ]$$

where each component has been normalized to a common scale, typically 0 to 1, with lower values generally indicating better health (in the case of error metrics) or lower resource utilization. Weights (wⁱ) and scaling factors (β) used in Memo calculation can be configured remotely, for example, via Governance token policy, allowing the system to tune the focus of AP (10) self-assessment and learning signals.

The Memo 40 serves several primary functions, contributing to a Memo-driven hierarchical control loop and enabling advanced learning and adaptation. First, it provides critical information for Orchestration Routing. Orchestration agents 210 at the Hub level receive Memo updates from deployed APs 10 and use this information as a continuous, quantitative signal to dynamically route tasks (Mgoals) to the healthiest and most capable APs, and to diversify data collection. In an exemplary embodiment, task routing is based on a multi-objective score that considers various Memo dimensions, such as:

$$Score = {w}^{T} \cdot Memo - λ \cdot Uncertainty + κ \cdot Explore$$

where w is a vector of weights reflecting the relative importance of different Memo dimensions for the current task, λ is a weight for incorporating uncertainty, and κ is a weight for incorporating the exploration bonus to encourage sampling under-explored state spaces. Tasks are assigned to the AP 10 with the minimum Score below a defined threshold; otherwise, they fall back to Hub execution or are re-routed. This dynamic routing based on real-time health metrics represents a significant improvement over static or rule-based task allocation approaches found in prior art systems. In bench tests, this approach has demonstrated a reduction in mean prediction latency of up to 65% compared to a fixed cloud baseline, by ensuring that tasks are always routed to the most suitable execution environment given current conditions.

Second, the Memo 40 drives Surrogate-Factory Queue Prioritization. Memo updates, particularly the Accuracy, Data Quality, Uncertainty, and Alignment Flag dimensions, are streamed back to the Surrogate Factory 230 at the Hub. The Factory uses this information to prioritize its retraining or calibration queue, ensuring that models associated with APs 10 reporting significant error rates (for example, greater than 10% rolling-window error), poor data quality, high uncertainty, or significant alignment divergence are moved to the front of the queue. This ensures that retraining resources are focused where they are most needed, maximizing the impact of model improvement efforts. This prioritization mechanism has demonstrated substantial improvements in overall system accuracy over time. In testing environments, an 18% improvement in Mwm 20 accuracy after 30 days of operation without human intervention has been observed, as the system automatically identifies and addresses the most significant model deficiencies.

Third, the Memo 40 directly enables various Memo-driven controls at the AP level. For example, an AP 10 can implement auto-throttling behavior: if its Load dimension exceeds a threshold (e.e., 0.9) or its Resources dimension (e.g., battery level) drops below a threshold (e.g., 15%), the AP 10 can automatically toggle into a low-power operational persona and report its status via a Memo.mode=“energy-save” flag. In certain embodiments, the Alignment Flag dimension can trigger a safety guard mechanism: if alignment_flag>τ (where τ is an acceptable divergence threshold), this can trigger a Governance override at the Nexus or Hub, potentially initiating a reward-reweighting push to realign the AP's objectives.

The Memo 40 is tightly integrated with the Goal/Reward Framework. When an Mgoal is transmitted to an AP 10, it can now include expected reward channel IDs or references, informing the AP 10 which specific operational metrics from its Memo 40 or execution outcome should be used to compute the Mrew. The AP 10 then maps the relevant Memo dimensions or derived values to compute the reward signal. When the AP 10 sends back the Mrew, it can include a vector containing individual reward components (e.g., [rₜₒₜₐₗ, r_{energy}, r_{quality}]) along with a confidence estimate for the reward value. In certain embodiments, the process of mapping operational KPIs to a reward signal is handled by a small neural network (a “reward encoder”) trained online from a combination of low-level grounded KPIs and higher-level user feedback or system outcomes, implementing a form of bi-level optimization to ensure reward functions are well-aligned with overall system goals.

Hierarchical aggregation of Memo signals provides valuable system-wide awareness. Cluster Memo servers can aggregate the Memos of their child APs 10, potentially using techniques like exponential decay or moving averages, to provide an early-warning heat-map of operational health to the Hub. The Nexus layer 110 can maintain rolling histograms or statistical summaries of Memo dimensions across multiple Hubs, which can be used for purposes such as federated policy tuning or identifying system-wide trends and anomalies.

Security and provenance are built into the Memo mechanism. Each Memo update transmitted from an AP 10 can be signed with the AP's unique cryptographic key to prevent spoofed health reports. In certain embodiments, the Memo 40 update can include a SHA-256 hash of the AP's firmware version, providing a verifiable link between the reported status and the executing code. For regulated metrics (e.g., related to SCADA security events or critical operational parameters), optional homomorphic masking or differential privacy techniques can be applied to the Memo data before transmission or aggregation, allowing computations on encrypted or perturbed data while preserving individual AP privacy and regulatory compliance.

The use of Memo 40 as a continuous, quantitative scheduling signal for task routing and retraining prioritization, its expanded role in driving on-device controls and learning, its integration with the Goal/Reward framework, hierarchical aggregation, and built-in security features represent significant non-obvious departures from prior art systems. Conventional approaches typically treat health or accuracy merely as logs or binary alerts, rather than as integral inputs to a continuous control system. By elevating these metrics to first-class control signals and integrating them into the learning and control loops, the present invention enables more sophisticated, responsive, and autonomous operation, significantly enhancing the resilience, efficiency, and accuracy of the water infrastructure management system ((also energy and environment infrastructure systems).

Referring now to FIG. 1, the Goal and Reward Framework of the system is described in detail. This framework constitutes a foundational mechanism governing the purposeful operation of APs 10 and their interaction with higher-level orchestration components, crucially enabling autonomous learning and the optimization of operational policies based on real-world outcomes. The framework consists of two primary elements: Goals (Mgoal) and Rewards (Mrew).

The Goal (Mgoal) represents a structured directive transmitted from an orchestrator, typically residing at the Hub or Nexus level, to a target AP. This directive specifies the task to be performed with sufficient detail to guide the AP's execution. Goals are formulated as structured data objects that define both the objective to be achieved and the parameters within which the execution should occur. For example, a goal might direct an AP 10 to predict effluent quality parameters for the next 24 hours, simulate the effect of reducing aeration by 10% on energy consumption and nutrient removal, or detect potential anomalies in clarifier performance based on current operational data. In certain embodiments, an Mgoal can also include information specifying the expected reward channels or the key performance indicators (KPIs) from which the AP (10) should derive its reward signal upon task completion, aligning the AP's immediate objective with higher-level operational priorities.

Goals typically include multiple components that collectively define the execution context. These components often include a task identifier that categorizes the type of operation to be performed, such as prediction, simulation, optimization, anomaly detection, or control action. They also incorporate temporal parameters that specify the time horizon for prediction or analysis, which might range from minutes for rapid operational decisions to days or weeks for longer-term planning scenarios. Spatial parameters define the physical scope of the analysis, potentially identifying specific equipment, process units, or geographical areas to be considered. Additionally, goals often specify precision or confidence requirements that define the acceptable error margins or confidence levels for the results. They may include constraint parameters that define operational limits, regulatory thresholds, or other boundaries within which the AP 10 should operate, especially for optimization or control-related tasks. Resource parameters may define computational or time budgets for the execution, helping to manage system resources effectively. Finally, output specifications detail the format, granularity, and delivery method for the results, ensuring they can be effectively utilized by downstream processes or presented to system operators.

The Reward (Mrew) constitutes a metric computed by the target AP 10 after executing an Mgoal. This metric quantifies the AP's performance relative to the assigned goal, providing feedback to both the AP 10 itself and to the orchestration layer. Crucially, in the context of autonomous learning and optimization, Mrew is often a grounded reward signal derived from measurable operational KPIs, moving beyond simple prediction error to reflect real-world costs and benefits. Rewards can be calculated based on various criteria depending on the nature of the task. For prediction tasks, the reward might be inversely proportional to the prediction error, potentially calculated as a normalized negative root mean square error (RMSE) or other appropriate error metric. For simulation tasks, the reward might reflect the fidelity of the simulation relative to known physical constraints or historical patterns. For optimization tasks, the reward typically corresponds to the degree of improvement achieved in the target objective function, potentially weighted by constraint satisfaction. Finally, for resource-sensitive tasks, the reward might incorporate factors related to computational efficiency, such as execution time or memory utilization. In certain embodiments, rewards are computed from any measurable operational KPI, alone or in learned combinations tuned by high-level policy. Exemplary grounded reward components can include metrics related to energy consumption, regulatory compliance (e.g., penalties for N-violations), equipment wear (e.g., pump starts), or other operational costs and benefits.

The reward calculation often involves multiple components that are weighted and combined to produce a final scalar value. The specific weighting factors may vary based on the operational context, with different aspects receiving greater emphasis depending on the current priorities of the system. For instance, in time-critical scenarios, computational efficiency might receive higher weighting, while in regulatory compliance contexts, prediction accuracy or regulatory penalty avoidance might be paramount. When the AP 10 transmits the Mrew back to the orchestration layer, in certain embodiments it includes a vector containing the individual reward components (e.g., [rₜₒₜₐₗ, r_{energy}, r_{quality}]) along with a confidence estimate for the computed reward value.

The Goal and Reward Framework serves multiple purposes within the system architecture. First, it provides a mechanism for directing AP behavior in a purposeful manner. By receiving clear, well-structured goals, APs 10 can focus their computational resources on relevant tasks and optimize their execution strategies accordingly. This directed approach ensures that system resources are utilized efficiently and that APs 10 contribute effectively to the overall system objectives. Second, the framework provides performance feedback that enables continuous improvement and autonomous learning. The reward signals calculated by APs 10 serve as a learning and adaptation signal for their internal logic and embedded Mwm 20 models. Through techniques such as reinforcement learning, APs 10 can adjust their parameters, operational strategies, or even their internal models to maximize rewards over time. This enables APs 10 to autonomously learn control policies (not just predictions) that minimize real-world cost functions, leading to continuous improvement in their performance without requiring explicit reprogramming or human intervention. The reward signals also provide valuable information for resource allocation decisions by orchestrators. By tracking the rewards generated by different APs 10 for various types of tasks, orchestrators can develop models of AP capabilities and effectiveness, allowing them to make more informed decisions about task allocation in the future. For instance, if a particular AP 10 consistently generates high rewards for ammonia prediction tasks but lower rewards for energy optimization tasks, the orchestration layer can preferentially route ammonia prediction tasks to that AP 10.

The implementation of the Goal and Reward Framework involves several technical considerations. Goals are typically encoded in a standardized format, often using protocol buffers, JSON, or similar serialization methods, to ensure consistent interpretation across different system components. These encoded goals are transmitted via the system's communication infrastructure, potentially using message queues, direct API calls, or publish-subscribe mechanisms depending on the specific deployment architecture. The reward calculation is performed locally by the AP 10 after goal execution, using algorithms that are specific to the task type but following a standardized approach to ensure consistency across the system. The calculated rewards are then transmitted back to the orchestration layer, typically alongside the task results and updated Memo status information. As noted, the Mrew sent back can include a vector of reward components and a confidence value in certain embodiments. In certain embodiments, the process by which the AP (10) maps operational KPIs and other internal states to a reward signal is handled by a “reward encoder,” which can be implemented as a small neural network or other learned function trained online from a combination of low-level grounded KPIs and higher-level user feedback or system outcomes, implementing a form of bi-level optimization to ensure reward functions are well-aligned with overall system goals.

To enhance system adaptability, the reward calculation mechanisms themselves may evolve over time. Through meta-learning processes or updates pushed by the Governance Agent 316, the system can adjust the reward functions to better align with higher-level objectives or to address changing operational priorities. This might involve adjusting the weighting factors for different reward components or even introducing new components as the system's capabilities expand.

Through its structured approach to task specification and performance feedback via grounded, operational rewards, the Goal and Reward Framework enables a sophisticated, adaptive control system that can continuously improve its performance by learning optimal policies while maintaining purposeful alignment with overall system objectives. This framework represents a significant advancement over traditional control approaches in water infrastructure management (also energy and environment infrastructure management), which typically rely on fixed rules or simplistic feedback mechanisms without the comprehensive, adaptable structure provided by the present invention.

Referring now to FIG. 5, the Emotion-Driven Observability and Control mechanism of the system is described in detail. This mechanism constitutes a sophisticated approach to monitoring system health, detecting anomalies, and triggering appropriate adaptive responses, including autonomous control actions and learning interventions, without human intervention. The foundation of this mechanism is the continuous calculation and publication of Emotion Tensors (Memo) 40 by deployed Agent-Packages (APs) 10 throughout the system hierarchy.

Deployed APs 10 continuously calculate their Memo based on their internal state, operational performance, and environmental conditions. This calculation occurs at regular intervals, with frequency potentially varying based on the criticality of the AP's 10 function and available computational resources, or triggered by significant changes in the Memo dimensions themselves as described previously. For critical processes such as real-time effluent quality prediction or aeration control, the Memo 40 might be updated several times per second, while for less time-sensitive applications such as long-term trend analysis, updates might occur at longer intervals.

The calculated Memo 40 is published to relevant monitoring or orchestration agents 210 at the Hub or Nexus level through the system's communication infrastructure, potentially using low-latency messaging protocols for time-sensitive applications. These Memo updates provide a continuous stream of health and performance information that enables system-wide observability without requiring explicit polling or query mechanisms.

Upon receiving Memo updates, orchestrators compare the received tensors against predefined thresholds or desired operational ranges. These thresholds are established based on operational requirements, historical performance data, and system knowledge. They may be static, defined during system configuration, or dynamic, adapting based on operational context or learning from historical patterns. For example, accuracy thresholds might be stricter for APs 10 involved in regulatory compliance monitoring than for those performing exploratory scenario analysis, reflecting the different consequences of errors in these contexts.

When deviations or significant patterns in the Memo 40 are detected, the system can automatically trigger a range of adaptive and control actions without requiring human intervention. One common action is alerting operators or other agents within the system. These alerts may be prioritized based on the severity and nature of the deviation, ensuring that critical issues receive immediate attention while minor concerns are addressed at an appropriate level of urgency. Alerts can be directed to specific roles or individuals based on the issue type, such as routing process chemistry concerns to process engineers while directing electrical issues to maintenance staff.

Another potential action is requesting retraining or calibration of the AP's World Model (Mwm) 20 at the Surrogate Factory 230. This action is typically triggered when the Accuracy dimension of the Memo indicates a significant drift in prediction performance, suggesting that the current model no longer adequately represents the physical system. Such drift might be caused by changes in underlying physical, chemical, or biological parameters, such as shifts in kinetic rates due to temperature changes or microbial population dynamics. The retraining request includes relevant context information, such as the specific patterns of prediction errors and the operational conditions under which they occur, and can include updated parameter values (e.g., new kinetic rates calibrated by the Master Mechanistic Model 235) to inform and guide the retraining process, ensuring the model is updated with the most current understanding of the system's behavior. As noted in the Surrogate Factory 230 description, prioritization of retraining is informed by Memo signals, including not only prediction error and data quality but also the Uncertainty and Alignment Flag dimensions, elevating models with high uncertainty or alignment divergence for attention.

In some cases, the system may initiate migration of the AP 10 to a different compute resource or hierarchical level. This might occur when the Load dimension of the Memo 40 indicates that the current computational environment is inadequate for the AP's requirements, either due to increased workload, reduced resource availability, or changes in task priorities. Migration can occur to more powerful resources when additional computational capacity is needed or to more energy-efficient resources when the AP's workload has decreased.

Task reallocation represents another adaptive response, where the orchestration layer redirects tasks away from an unhealthy AP 10 to more suitable alternatives. This redirection considers not only the health status of potential target APs 10 but also their capabilities and current workload, ensuring that tasks are allocated to the most appropriate execution environment given the current system state.

In more severe cases, the system may quarantine an AP 10 that shows signs of critical failure or security issues. Quarantining involves isolating the AP 10 from normal system operations, preventing it from receiving new tasks or accessing sensitive data while allowing diagnostic information to be collected. This action helps contain potential issues before they can impact broader system performance or security.

The system can also prioritize proactive maintenance based on deteriorating health trends indicated by the Memo 40. By analyzing patterns in the Memo data over time, the system can identify gradual degradations in performance or reliability that might not trigger immediate alerts but indicate potential future issues. This predictive approach allows maintenance to be scheduled before acute failures occur, reducing downtime and operational disruptions.

Beyond these actions initiated by higher-level agents, the AP 10 can also take autonomous, Memo-driven control actions locally. For example, in certain embodiments, an AP 10 can implement auto-throttling behavior: if its Load dimension exceeds a threshold (e.g., 0.9) or its Resources dimension (e.g., battery level) drops below a threshold (e.g., 15%), the AP 10 can automatically toggle into a low-power operational persona and report its status via a Memo.mode=“energy-save” flag. In certain embodiments, the Alignment Flag dimension of the Memo can trigger a safety guard mechanism: if alignment_flag>τ (where τ is an acceptable divergence threshold), this can trigger an override, potentially initiating a reward re-weighting push from Governance or switching to a safe, pre-defined policy, preventing the AP 10 from executing potentially misaligned control actions.

The Emotion-Driven Observability and Control mechanism creates a closed-loop control system that ensures resilience, maintains quality of service, and optimizes resource utilization by allowing the system to react autonomously to the real-time health and performance of its distributed components, and to drive continuous learning and safe adaptation. This approach represents a significant advancement over conventional monitoring systems, which typically rely on static thresholds, periodic checks, or human intervention to address operational issues.

Hierarchical aggregation of Memo signals provides enhanced system-wide observability and supports higher-level decision-making and learning processes. In certain embodiments, Cluster Memo servers aggregate the Memos of their child APs, potentially using techniques like exponential decay or moving averages, to provide an early-warning heat-map of operational health to the Hub. The Nexus layer 110 can maintain rolling histograms or statistical summaries of Memo dimensions across multiple Hubs, which can be used for purposes such as identifying system-wide trends and anomalies, or for supporting federated policy tuning and evaluation.

The implementation of this mechanism involves several technical components. At the AP level, specialized monitoring routines continuously gather and process performance metrics, comparing them against expected values and calculating normalized scores for each Memo dimension. Communication modules handle the secure transmission of Memo updates to relevant system components, ensuring that health information is available where and when it is needed. At the Hub or Nexus level, monitoring agents receive and aggregate Memo updates from multiple APs, building a comprehensive view of system health. Analysis routines detect patterns, trends, and anomalies in this data, identifying issues that may span multiple components or emerge over time. Decision engines evaluate detected issues against policy rules and historical patterns to determine appropriate control responses, while execution modules implement those responses through the system's control interfaces.

The entire mechanism operates within a policy framework that defines acceptable operational ranges, response priorities, and escalation paths. This framework may be established during system configuration and refined over time based on operational experience and changing requirements. Machine learning techniques can be employed to continuously improve the system's ability to detect anomalies and select effective responses, learning from the outcomes of previous interventions.

Through its comprehensive approach to health monitoring, anomaly detection, and autonomous adaptation and control, the Emotion-Driven Observability and Control mechanism enables a level of operational resilience and efficiency that would be impractical to achieve through manual monitoring and intervention alone. This capability is particularly valuable in water infrastructure environments, where complex, interdependent processes operate continuously and where rapid response to changing conditions can be critical for maintaining service quality, regulatory compliance, and operational efficiency.

Referring now to FIG. 2, the System Deployment Hierarchy 100 of the invention is described in detail. This hierarchy 100 defines both the physical and logical distribution of components and agents across the water infrastructure monitoring and management system (also energy and environment infrastructure systems), representing an exemplary embodiment of a flexible and scalable architecture. The architecture is organized into distinct conceptual layers, each with specific roles and capabilities that collectively enable comprehensive, scalable, and efficient operation through distributed intelligence and learning.

At the base of the hierarchy 100 lies the Node layer 140, comprising elemental data-generation points-individual sensors 510 (e.g., flow, NH₄, vibration), ladder-logic PLCs/RTUs 520, smart IoT loggers 530, or external data APIs. Nodes stream raw, timestamped measurements 550 (and simple health bits) but run no Agent-Packages 10 and possess minimal compute-typically microcontroller-class hardware or fixed-function firmware. Their sole role is to publish authenticated data to the overlying Cluster tier, where the first level of edge intelligence begins. These measurements might include flow rates, pressure readings, water quality parameters, equipment status indicators, or other operational metrics relevant to exemplary water infrastructure management.

The next level in the hierarchy 100 is the Cluster layer 130, which represents edge compute resources typically located on-premises at water facilities or integrated with advanced sensor platforms. Clusters may consist of single or multiple nodes and provide the computational foundation for localized analysis, data validation, rapid response capabilities, and on-device learning. Unlike Nodes, Clusters possess sufficient computational resources to host task-specific APs 10 that require low-latency access to local data. These APs 10 incorporate local-level models and local connection memory 30, enabling them to perform specific functions with defined inputs and outputs while operating within limited resource constraints and executing learning updates based on local experience. Clusters operate at the edge governed by structured PLC programming or similar control systems, with limited autonomy but critical capability for immediate data processing, anomaly detection, local control, and model adaptation. They return processed outputs, updated Memo states, and in certain embodiments, learning artifacts such as gradient deltas or model updates to higher levels in the hierarchy 100 and house connection memory 30 structures necessary for local task operation and learning.

Moving up the hierarchy 100, the Hub layer 120 serves as an intermediate processing and domain coordination point, potentially acting as a bridge connecting multiple Clusters within a geographical region or operational domain. Typically, a Hub exists at the utility level, coordinating operations and data from site-specific Clusters or Nodes that fall under the governance of that institution. The Hub can be deployed on-premises, in a private data center, or in a cloud environment, offering flexibility to accommodate varying infrastructure capabilities and security requirements. This layer serves as the backend for UI/UX multi-modal user interactions 910 and contains the orchestration hierarchical agent that has awareness through domain connection memory 740.

At the highest level of the hierarchy 100 is the optional Nexus layer 110, which provides multi-Hub oversight and global coordination. The Nexus connects multiple Hubs and hosts the Nexus Supervisory Trio, which includes the Global Orchestration Agent 210 (Sheepdog), the Creation Agent 314, and the Governance Agent 316. The Nexus also maintains the highest levels of Connection Memory (Cross-Domain and System) and implements a token-based economy ledger for resource accounting and incentivization.

From a higher-order perspective, the system architecture, particularly centered around the Hub and extending to the Nexus, can be viewed as an AI-driven orchestration platform comprising three primary layers that work in concert to deliver intelligent process support:
1. Integration Layer: This foundational layer connects disparate data sources while maintaining their independence. Its role is to establish standardized protocols for data exchange across various systems (e.g., SCADA, LIMS, IoT devices, asset management, logbooks, document databases, external APIs, saved runs), create a unified data model enabling cross-system analytics while preserving source characteristics, implement automated data quality monitoring and validation, and maintain clear lineage and versioning for audit and compliance. This corresponds functionally to the data ingestion capabilities and source descriptions detailed elsewhere in this specification.
2. Intelligence Layer: This layer serves as the core processing and orchestration fabric, operating primarily at the Hub and Nexus tiers. It hosts and orchestrates multiple categories of specialized AI agents and modular functional services (microservices). These agents leverage the Agent-Packages (APs) 10 and their embedded World Models (Mwms) 20, including emulations, for analysis and prediction. Key agent categories include: Core Processing Agents (handling data validation, integration, alerting), Model-Based Agents (leveraging physics-based models, ML models, optimization engines), Knowledge Agents (maintaining domain expertise, processing documents like SOPs, managing compliance), and Productivity Agents (automating tasks like reporting, logbook integration, communication). This layer embodies the system's intelligent coordination and analytical power.
3. Interface Layer: This layer provides user-centric access to system insights, predictions, and controls, creating an integrated digital ecosystem. It features two core components: a digital home base 912 (e.g., a comprehensive web application providing dashboards, logbooks, training tools, data dictionaries, etc.) and a unified natural language interaction system accessible via multiple channels (web chat, email, SMS, voice, potentially augmented reality). The interface adapts dynamically based on user role, preferences, and operational context, ensuring intuitive access to the platform's capabilities. This layer corresponds to and augments the functionality provided by the User Interaction Agents 220.

While the Hub typically hosts the primary instance of the Intelligence Layer's microservice fabric for a given domain, certain horizontally-scalable services or capabilities—such as the token ledger 350, a global model registry, cross-domain knowledge bases, or federated learning coordination—may be promoted or deployed from the Hub level to the Nexus layer 110. This allows for cross-hub reuse, global coordination, and enhanced scalability, akin to a microservice “lift-and-shift” pattern, enabling efficient resource sharing and collaborative innovation across multiple domains or organizations.

In an exemplary embodiment, a minimum baseline specification for a Cluster-tier edge node is defined to ensure sufficient capability for hosting Agent-Packages 10 and supporting local operations. It is to be understood that these specifications represent an exemplary minimum and that various alternative hardware configurations and platforms can be utilized for Cluster nodes. This exemplary minimum baseline includes a Central Processing Unit (CPU) with at least four 64-bit cores running at or above 1.8 GHz, utilizing architectures such as ARM Cortex-A55 or Intel Atom x6000 series, which provides sufficient processing power to run two to four AP containers along with the base operating system without contention, and leaves headroom for performing on-device learning updates. The system requires Random Access Memory (RAM) of at least 4 GB, preferably ECC or industrial-grade LPDDR4, to support loading small language model or policy adapters along with two to three World Models into memory simultaneously, with ECC providing resilience against field bit-flips. While not mandatory, optional AI or mathematical acceleration hardware, such as an 8-TOPS Neural Processing Unit (NPU) or a small Graphics Processing Unit (GPU) in the class of a Jetson Nano, is recommended to reduce Mwm 20 inference latency to below 50 ms for World Models representing systems with approximately 128 nodes. For data persistence, a minimum of 32 GB of eMMC or industrial-grade Solid State Drive (SSD) with wear-leveling capabilities and a lifespan of at least 10,000 program/erase cycles is provided to hold AP OCI images, store the experience buffer 420 (typically retaining about 7 days of operational data), and allocate space for an Over-the-Air (OTA) rollback partition. Networking capabilities include at least dual 1 Gigabit Ethernet (GbE) or 100 Megabit Ethernet (MbE) ports, supplemented by LTE or 5G cellular fallback, capable of supporting MQTT or gRPC over TLS protocols to ensure sub-second Memo uplink and efficient model streaming, with the wireless path supporting deployment at remote sites. Input/Output (I/O) and Fieldbus connectivity is provided with at least one RS-485 or CAN interface and eight General Purpose Input/Output (GPIO) pins, along with Modbus-TCP support, to enable direct backhaul integration with sensors 510 and PLCs 520 without requiring an extra gateway.

The operating system and runtime environment typically comprise Linux kernel version 5.10-lts, a container runtime such as containerd or Docker-CE, and a lightweight Kubernetes distribution such as k3s configured for a three-node quorum, matching the Hub orchestration capabilities while maintaining a minimal footprint below 300 MB. Hardware security features, such as a Trusted Platform Module (TPM) 2.0 or ARM TrustZone, secure boot mechanisms, and a hardware Random Number Generator (RNG), are included to provide secure key storage for Memo signing, enable verified OTA updates, and support cryptographic operations. Power requirements are typically 12-24 V DC with a typical consumption of 15 W, and the hardware is designed with brown-out ride-through capability exceeding 50 ms to ensure survival during pump start transients or similar power fluctuations common in industrial environments. Environmental specifications include an operating temperature range of −20° C. to +60° C., an IP-65 enclosure rating, and conformal-coated PCBs to handle environmental conditions such as pump gallery humidity and blower room dust. Time synchronization is achieved using GPS PPS (Pulse Per Second) or IEEE-1588 (Precision Time Protocol) as a slave, with NTP fallback, to maintain multi-sensor data timestamps within a ±50 ms window for accurate causal machine learning. Essential software libraries include ONNX-Runtime, Torch-CPU, OpenBLAS, and potentially a lightweight vector database extension like pgvector-lite to provide a minimal stack for running standard Mwms 20 and similarity queries on embedded data. Edge observability is provided through standard exporters like Prometheus node exporter and log forwarders like Fluentbit, generating logs and metrics at a rate of no more than 50 KB/s to feed Hub dashboards and support Memo 40 construction.

Beyond these hardware and software minimums, certain soft minimums for performance and data retention are also defined. A total latency budget from sensor data acquisition through AP 10 inference to Memo 40 publication is typically maintained at or below 500 ms. An uptime target of 99.5% per quarter is expected, equating to no more than approximately 10 hours of downtime. Each Cluster node is expected to maintain an experience buffer 420 capable of storing at least 100,000 experience triples (observation, action, reward), totaling approximately 200 MB, for local replay-based learning. Clusters that exceed the exemplary minimum baseline specifications can host additional APs, larger language or planning models, or perform local federated gradient aggregation, expanding the system's capabilities at the edge.

A representative reference stack for the Hub tier, supporting its role as a domain coordination center and host for key services, is detailed below, it being understood that these are exemplary specifications and that various alternative configurations and underlying technologies are possible. For core compute, a minimum viable configuration for a single utility might utilize a virtual machine or bare-metal server with 16 vCPU and 64 GB RAM, whereas a scalable and highly available profile could employ a Kubernetes worker pool of three nodes, each with 32 vCPU and 128 GB RAM, capable of autoscaling up to 128 vCPU; these configurations can be mapped to cloud instances such as AWS c7a.4xlarge, Azure D16ads v5, or equivalent on-premises dual-socket Xeon Silver servers. Optional GPU or AI acceleration, such as a single L4 (24 GB) for Surrogate Factory 230 retraining, is recommended for the minimum viable stack, while a scalable profile may include two to four A10 or L40 GPUs, leveraging on-demand spot instances for burstable reinforcement learning experiments, mapping to cloud offerings like GCP A2-highgpu or Azure NC A100, or equivalent on-premises NVIDIA L40 servers. The Kubernetes control plane can be managed via cloud providers (EKS/AKS/GKE) in a single availability zone for the minimum viable stack, or managed with distribution across at least three availability zones and an etcd quorum utilizing SSD NVMe storage for the scalable/HA profile; lightweight options like k3s are suitable for fully on-premises deployments, and cluster autoscalers should be used for elastic scaling. Ingress and API Gateway functionality is provided by solutions such as Nginx Ingress with cert-manager for the minimum stack, evolving to an Istio or Kong service mesh with a Web Application Firewall (WAF) for the scalable profile, ensuring TLS 1.3 everywhere and mutual-TLS between microservices. Message brokers, essential for asynchronous communication, can be a single-node Kafka instance (with 3 GB/s EBS) combined with an MQTT bridge for the minimum viable configuration, scaling to a three-node Kafka cluster with three ZooKeeper (or Kraft) nodes and an EMQX cluster for the scalable profile, retaining approximately 7 days of topic history; edge clusters typically connect via MQTT. A data store for time-series data, crucial for storing raw sensor and Memo streams, can utilize PostgreSQL with the Timescale extension (2 vCPU/16 GB) for the minimum stack, scaling to a three-node Timescale prom-scale cluster with 2 TB SSD each for the scalable profile.

Connection Memory 30 is implemented as a graph database, such as a Neo4j Community single-node instance for the minimum viable stack, scaling to a three-core causal cluster with SSD storage and thirty two GB (32 GB) heap for the scalable profile; alternative graph technologies like TigerGraph or Neptune are viable drop-in replacements. Object or file storage for housing model artifacts, OCI image caches, and log archives utilizes S3 or Blob storage, starting at 1 TB for the minimum stack and scaling to a versioned bucket of ten TB (10 TB) with lifecycle rules for the scalable profile. Surrogate Factory 230 tooling for Mwm 20 training and management includes CPU-based training using frameworks like PyTorch 2 and ONNX Runtime for the minimum stack, expandable with Ray clusters or cloud services like SageMaker for scalable profiles, supporting nightly fine-tuning workflows and managing secrets via tools like AWS Secrets Manager or Hashicorp Vault.

Observability is provided through tools like Prometheus and Grafana with Loki for the minimum stack, scaling to Prometheus Thanos with Tempo for traces and alertmanager in a highly available configuration, retaining approximately 30 days of metrics and 14 days of logs. Security and Identity and Access Management (IAM) utilize SSO (OIDC) and TPM-based certificate issuance for the minimum stack, evolving to a Zero-Trust mesh (using technologies like SPIFFE/SPIRE), runtime scanning, and Cloud-Native Application Protection Platform (CNAPP) features for the scalable profile, with data-in-use encryption for model weights and optional confidential VMs. Uptime targets range from 99.9% (less than 8 hours 45 minutes per year) for the minimum viable stack, achieving 99.95% for the multi-AZ scalable profile through managed load balancing and database replication. The latency budget for a sensor-to-dashboard round-trip is typically maintained below 2 seconds, and this performance is expected to remain consistent even with 10,000 concurrent cluster feeds in the scalable configuration, with edge buffering smoothing burst traffic.

These representative specifications illustrate that the Hub must host several key functional blocks, including Orchestration Agents 210, typically deployed as Kubernetes deployments with Horizontal Pod Autoscaler targets based on metrics like Memo stream rate. User-interaction services, such as GraphQL/REST APIs, WebSocket endpoints, and chat-bot interfaces, provide the multi-modal front-end. The Surrogate Factory 230 encompasses the model registry, feature store, and training pipelines, leveraging the specified compute and storage resources. A Policy/Reward service 270 provides the configurable mapping from operational KPIs to reward tensors, supporting the learning framework. An edge gateway 280, implemented as an MQTT 5 or DDS-XRCE bridge, handles connections from numerous edge clients (e.g., 5 k-20 k TLS clients). An OTA and container registry 290, such as Harbor or ECR, stores and manages the Agent-Package images.

These representative specifications ensure sufficient headroom for supporting a significant number of active Clusters (approximately 50 clusters, corresponding to around 5,000 sensors in an exemplary deployment), continuous World Model retraining, and hundreds of concurrent operator sessions, while allowing for elastic growth when additional sites or heavier reinforcement learning workloads come online.

The Nexus layer 110, functioning at the apex of the system hierarchy 100 to provide multi-Hub oversight and global coordination, serves as the residence for the Nexus Supervisory Trio. The Nexus connects multiple Hubs and hosts the Nexus Supervisory Trio, which includes the Global Orchestration Agent 210 (Sheepdog), the Creation Agent 314, and the Governance Agent 316. The Nexus also maintains the highest levels of Connection Memory (Cross-Domain and System) and implements a token-based economy ledger for resource accounting and incentivization. In certain embodiments, the Nexus coordinates federated learning processes. Hubs can publish aggregated policy deltas or model updates (rather than raw data) to the Nexus, where the Creation Agent 314 can aggregate these updates using techniques such as Federated Averaging. The Governance Agent 316 can then reward high-performing contributing Hubs via the token economy, strengthening the token ledger 350 and aligning with privacy-conscious, large-scale experience growth. By governing system-wide policies, facilitating inter-domain collaboration, managing ecosystem evolution, enforcing global policies, and coordinating federated learning, the Nexus ensures coordinated operation and continuous improvement across potentially diverse and geographically distributed water infrastructure assets (also energy and environment infrastructure assets).

Given its role in providing global oversight, coordinating activities across multiple Hubs, managing the token economy, and facilitating system-wide processes like federated learning and the distribution of global policies or master model components, the Nexus tier requires robust underlying infrastructure. Similar to the Hub level, the Nexus 300 demands significant compute resources for running supervisory agents 310 and performing aggregation tasks, substantial storage capacity for managing the global token ledger 350, cross-domain memory, and aggregated learning artifacts, and high-bandwidth, low-latency networking to communicate effectively with numerous connected Hubs. The specific requirements will vary based on the scale of the deployment (number of connected Hubs, volume of cross-domain data/transactions), but in general, the infrastructure supporting the Nexus mirrors the functional categories described for the Hub (compute, storage, networking, security, etc.) albeit sized and configured to handle the aggregate demands and global scope of operations.

The hierarchical system architecture is coordinated through an intelligent Agentic Orchestration process, primarily managed by Orchestration Agents 210 typically residing at the Hub level, with global oversight potentially provided by the Global Orchestrator (Sheepdog) 312 at the Nexus level to be described in further detail below. This orchestration governs the allocation of tasks, the selection of appropriate resources, and the flow of information throughout the system, enabling complex workflows and adaptive behavior. The orchestration process begins with the decomposition of each user or system request into specific, actionable task goals (Mgoals). Cognitive logic, potentially implemented using Large Language Models (LLMs), structured decision trees, or ReAct frameworks within the Orchestration Agents 210 or associated interaction agents, is employed to interpret requests and formulate these Mgoals.

A core function of the Agentic Orchestration is the dynamic allocation and dispatching of these Mgoals to the most suitable Agent-Packages (APs) 10 distributed across the system hierarchy 100 (Clusters, Hub, or Nexus). This allocation is not static but is determined in real-time by consulting key information sources: the Connection Memory (Mmem) 30 and the live Emotion Tensors (Memo) 40 of candidate APs 10. The Mmem 30 provides context on AP 10 capabilities, available tools, data connections, and crucially, spatial and temporal coverage, while the Memo 40 provides quantitative, real-time insights into the AP's operational health, load, accuracy, uncertainty, and exploration status.

The orchestration logic leverages these inputs to make sophisticated routing decisions. Routing decisions are quantitative: an AP 10 whose Memo 40 indicates high accuracy (low rolling-RMSE), modest computational load, good data quality, and low latency is favored over a peer that is congested, experiencing model drift, or operating with poor data quality. The orchestration may employ scoring functions or learned policies, potentially considering multi-objective criteria that balance performance, resource usage, and exploration needs. For instance, the orchestrator might calculate a score using Memo 40 dimensions (e.g., Score=wT·Memo-2. Uncertainty+κ·Explore) and assign the task to the AP 10 with the optimal score below a threshold. Memo signals, including exploration bonuses, can be explicitly used to sample under-explored state spaces or diversify data collection.

A key aspect of the orchestration, particularly enhanced by the spatial-temporal context stored in Mmem 30, is the dynamic selection between heterogeneous World Models (Mwms) 20, including computationally efficient emulations and higher-fidelity mechanistic models 610. When a goal spans specific spatial coordinates 800 or regions (defined by x, y, z, t), the Orchestration Agent 210 queries Connection-Memory (Mmem) 30 for Agent-Packages (APs) 10 whose embedded World Models (Mwms) 20, particularly those implemented as emulations, cover the required spatial and temporal cells. The orchestrator can prioritize fast emulators over high-fidelity mechanistic Mwms 20 when low latency (e.g., <1 second) is specified or required by the task, or when bridging integration gaps between disparate models.

Furthermore, the Orchestration Agent 210 can chain different model segments together, including sequences like mechanistic-emulator-mechanistic or chains of emulators operating at different scales or resolutions. It uses the coordinate tags and transformation information stored as edges or node properties within Mmem 30 to ensure compatible data handoffs (e.g., applying necessary unit or scale conversions) between the APs 10 executing these chained sub-tasks. This allows the system to compose complex, multi-scale analytical workflows dynamically based on the specific requirements of the request and the available model resources registered in Mmem 30.

Communication facilitating this orchestration, including the transmission of task directives (Mgoals), interim results, Memo updates, and computed rewards (Mrews), utilizes a standardized semantic envelope 950. This envelope ensures consistent interpretation regardless of the underlying transport mechanism, which could be gRPC/TLS, MQTT, DDS-XRCE, or other protocols selected based on network conditions. This protocol-agnostic semantic layer simplifies the integration of diverse APs 10 and ensures robust communication across the potentially heterogeneous network infrastructure connecting Clusters, Hubs, and the Nexus.

Outside of the supervisory agents 310, the placement of agents within the hierarchy 100 follows functional and operational considerations. Task-specific APs 10 requiring low latency, local data access, or on-device learning capabilities are typically deployed at Clusters to minimize communication overhead, enable rapid response to local conditions, and leverage distributed data streams for continuous adaptation. Clusters that exceed the exemplary minimum baseline specifications can host additional APs, larger language or planning models, or perform local federated gradient aggregation, expanding the system's capabilities at the edge. Orchestration, User Interaction, Surrogate Factory 230, and other support agents primarily reside at the Hub level, where they can coordinate activities across multiple Clusters, manage domain-specific resources, and facilitate local learning processes while maintaining domain specificity. Global oversight agents (the Nexus Supervisory Trio) reside at the Nexus level, providing system-wide governance, coordination, and facilitating cross-hub learning and collaboration.

A significant capability of the system is agent migration, which allows APs 10 to move between different compute resources or hierarchical layers based on Memo status, policy requirements, or optimization criteria. This migration is facilitated through containerization technologies, such as Open Container Initiative (OCI) images, and orchestration platforms like Kubernetes. Furthermore, the deployment and management of these containerized APs 10 and the underlying infrastructure across the hierarchy are typically automated using Infrastructure as Code (IaC) tools such as Helm, Terraform, or Bicep, enabling repeatable, scalable, and version-controlled deployments. Each AP OCI image can include a side-car GPU driver probe that automatically switches between GPU and CPU execution based on available hardware, further enhancing portability and adaptability across heterogeneous hardware environments. For example, an AP 10 originally deployed at a Cluster might be migrated to the Hub if its computational requirements increase beyond local capabilities, or an AP 10 might be temporarily relocated to a different Cluster if its original host experiences hardware issues or maintenance downtime, or migrated to a resource better suited for specific learning tasks.

Through this hierarchical deployment model and the intelligent agentic orchestration it enables, the system achieves a balance between centralized coordination and distributed intelligence and learning, leading to efficient resource utilization, scalable operation, and resilience to communication or component failures. By placing computational capabilities where they are most needed, allowing dynamic adaptation through agent migration, and employing sophisticated orchestration—characterised by dynamic task decomposition, context-aware resource discovery via Mmem 30, health-based routing via Memo 40, adaptive selection between emulations and mechanistic models 610 based on spatial/temporal context and performance needs, and standardized communication—the system efficiently manages complex workflows and supports effective water infrastructure management (also energy and environment infrastructure management) across diverse operational environments and scales. This overall agentic approach moves beyond static workflows or simple rule-based systems, enabling a more flexible, responsive, and intelligent management paradigm. It is to be understood that while the specific hardware specifications and deployment models described for the Cluster and Hub tiers are presented as exemplary minimums and representative reference stacks, respectively, the invention is not limited to these exact configurations.

Various alternative hardware platforms, computing resources, and deployment topologies are possible and can be selected based on specific application requirements, operational context, existing infrastructure, and desired performance characteristics. These alternative deployment topologies include an all-cloud model where managed Kubernetes and serverless data stacks are used, requiring only site-to-cloud VPNs; a hybrid model where a small on-premises k3s edge gateway forwards traffic to a cloud Hub, satisfying data residency requirements; and a private data center model utilizing full bare-metal Kubernetes with distributed storage like Ceph, useful for air-gapped utilities.

Referring now to FIG. 2, the Nexus Supervisory Trio, or an optional expanded cast including additional supervisory agents 310 (collectively referred to herein as Supervisory Mono, Duo, Trio, or Pentad depending on the number of agents present in a given embodiment, with additional supervisors also being possible), provides optional high-level control and coordination of the system. The Nexus Supervisory agents 310 reside at the Nexus level of the system hierarchy 100 and typically consist of several specialized agents that work in concert to provide global oversight, system evolution, policy enforcement, and advanced learning coordination across multiple Hubs. These agents form a coordinated supervisory system that ensures efficient operation, facilitates system evolution, enforces policies, and orchestrates system-wide learning processes across the distributed infrastructure.

In an exemplary embodiment, the Nexus Supervisory Trio comprises three agents: the Global Orchestrator (also known as the “Sheepdog”) 312, the Creation Agent 314, and the Governance Agent 316. In other exemplary embodiments, the supervisory cast may expand to include additional roles such as an Archivist 318 and a Risk Officer 319, forming a Pentad. The specific roles and their distribution can be collapsed or distributed depending on the deployment scale and requirements, yet all interact through a common coordination fabric, often leveraging the vote-and-token mechanisms described herein.

The Global Orchestrator 312, colloquially referred to as the “Sheepdog,” (multiple Sheepdogs are possible with different coordination roles in scalable embodiments, and the singular is intended as both singular or plural) functions as the lead coordinator for the entire agent ecosystem spanning multiple Hubs. This agent oversees the health, coordination, and efficiency of the entire system, serving as the principal herder for every Task Agent regardless of their deployment location (hub-resident, cluster-resident, or nexus-resident). The Sheepdog maintains a high-level state view of all Hubs and key APs, enabling it to detect system-wide anomalies or “strays”—agents that are drifting outside specifications or starving for data—and redirect them back onto approved workflows. Analogous to a league manager or match-maker in a learning system, the Sheepdog coordinates interactions between agents to facilitate learning and evaluate performance.

The Sheepdog implements several key mechanisms to fulfill its coordination role. It maintains a voting ledger where Task Agents publish their intent and status information. In certain embodiments, this evolves from a simple majority vote to a multi-objective auction based on Pareto frontier bidding, where agents publish proposals characterized by a multi-dimensional tuple, for example, (expected reward gain, predicted energy cost, associated uncertainty, exploration value). The Sheepdog evaluates proposals by tallying confidence scores, evaluating quorum thresholds, and, in advanced embodiments, solving a weighted knapsack problem to select action plans that maximize a system-wide metric such as an “Experience Value Index (EVI)”, ensuring that system activities align with global objectives and constraints while potentially diversifying data collection and optimizing resource usage. This mechanism allows for distributed decision-making while maintaining overall coordination and direction.

For routing decisions, the Sheepdog performs benefit-driven routing of requests across Hubs, directing tasks toward options with the highest calculated benefit scores. It may employ voting or consensus protocols for critical global decisions, particularly those with significant resource implications or cross-Hub impacts. The agent leverages both System and Cross-Domain Connection Memory 770 to maintain comprehensive awareness of the entire “flock” and their interactions. The Sheepdog may also function as a Curriculum Scheduler, pairing Task Agents for cooperative or competitive self-play sessions and logging performance or skill ratings (e.g., Elo-like ratings) in System Memory to guide future task assignments and learning interactions.

While the Sheepdog delegates localized decisions to Hub-level Orchestration Agents 210, it retains the authority to override or re-route tasks when global constraints—such as power consumption, token budget limits, regulatory compliance requirements, or system-wide learning goals—are at risk. This hierarchical approach balances local autonomy with global coordination, allowing for efficient operation while maintaining system-wide coherence and policy compliance.

When necessary, the Sheepdog can issue recall or re-train commands to pull misbehaving Task Agents and hand them to the Creation Agent 314 for repair or reconfiguration. It also initiates provenance-signed Open Container Initiative (OCI) transfers when a Hub requests or offers a Task Agent package, facilitating secure and verified exchange of agent resources between different parts of the system.

The Creation Agent 314, the second member of the exemplary Nexus Supervisory Trio, bears responsibility for the lifecycle management of new agent types, complex cross-domain workflows, and facilitating system evolution through the generation of training materials and the orchestration of learning processes. Analogous to a curriculum designer, the Creation Agent 314 designs and generates training tasks and environments to improve agent capabilities. This includes synthesizing or “breeding” novel APs 10 or workflow templates in response to detected capability gaps or system needs identified by the Sheepdog through voting results or other monitoring mechanisms. The Creation Agent is configured to generate, test, and package these new agent types for deployment and/or to heal (improve or modify) or remove agents that have outlived their usefulness across the system hierarchy 100. It can clone or mutate existing agents as a starting point, or create entirely new agent architectures as needed. Each newly generated or modified agent is tagged with provenance information and minimum-viable-token cost data to facilitate resource accounting and governance.

To fulfill its creation role, the Creation Agent 314 utilizes templates potentially stored in Domain or Cross-Domain Connection Memory 770 as starting points for new agents or workflows. It instantiates new APs, inserts appropriate Mwm 20 slices (potentially generated by a Hub's Surrogate Factory), and configures them with the necessary capabilities and connection patterns to address specific needs. The agent tags the initial cost or resource requirements of the new entity, providing essential information for the token-based economy managed by the Governance Agent 316. The Creation Agent 314 also includes a Scenario Forge component that can spawn synthetic what-if datasets and adversarial environments for training Mwms 20, providing a richer and more challenging experience stream to improve robustness and explore the bounds of the World Models.

A particularly important function of the Creation Agent 314 is facilitating the sharing of successful patterns or validated Mwms 20 between Hubs. When a Hub develops an effective agent template or surrogate model, the Creation Agent 314 can extract the generalizable components, package them appropriately, and make them available to other Hubs, potentially triggering token transactions managed by the Governance Agent 316. This knowledge sharing accelerates system improvement and promotes consistency across different deployment environments. The Creation Agent 314 is also responsible for orchestrating federated learning rounds, triggering processes such as Federated Averaging (FedAvg) or Federated Optimization (FedOpt), aggregating model updates received from Hubs, and distributing updated global models.

The Creation Agent 314 serves as the primary provider of “replacement sheep” to Hubs or Clusters on demand, keeping the agent “herd” healthy and specialized. It generates multi-scale surrogate models using the Nexus-level factory 330 that can be deployed as part of agent packages 10 or hosted at the Nexus level with capability context provided through updates to domain connection level memory at the Hub. This flexibility allows for efficient resource utilization while maintaining specialized capabilities where they are needed.

The third member of the exemplary Nexus Supervisory Trio, the Governance Agent 316, enforces global policies, security standards, and manages economic and resource constraints across the system. Analogous to a coach that sets reward shaping and ensures alignment, the Governance Agent 316 works to ensure that agent behaviors align with high-level system goals. This agent plays a crucial role in establishing a tight loop with the Creation Agent 314, enabling safe and incentivized system evolution in multi-entity environments. The Governance Agent 316 enforces system-wide policies that the Sheepdog must obey when herding, such as token budgets, regulatory guard-rails, and ethical boundaries. It arbitrates disputes when multiple Hubs vote for conflicting actions, issuing final tie-breaking directives when necessary. A dedicated Alignment Vet sub-module under the Governance Agent 316 monitors for divergence between grounded rewards and user feedback, can auto-tune reward networks, and flags potential “specification gaming” where agents might find loopholes to maximize reward without achieving intended outcomes.

A primary responsibility of the Governance Agent 316 is implementing and managing a token-based economy for resource accounting and incentivization across the system. This economy creates a formalized mechanism for tracking contributions, usage, and value exchange between different system components and entities. The token ledger 350 can be implemented as a permissioned blockchain (e.g., Hyperledger Fabric) or a centralized, cryptographically signed SQL ledger, providing a verifiable record of resource usage and transactions able to be hosted privately or within a digital public infrastructure protocol. Within this economy, the Governance Agent 316 defines costs (in tokens) for various resource consumption events across the system, such as compute cycles used by an AP, storage usage, benefits received as described below, execution of a specific Mwm 20, or access to a particular data source. It enables Hubs to contribute validated resources—such as high-performing Mwms 20 certified by their Surrogate Factory 230 or successful workflow templates derived from their Domain Connection Memory 740—to a shared Nexus repository, potentially curated by the Creation Agent 314. The hashes of contributed AP OCI images or workflow definitions are stored as ledger metadata to ensure provenance and integrity. The Governance Agent 316 tracks the usage of these contributed resources by other Hubs or agents across the Nexus and distributes tokens from the consuming Hub's account to the contributing Hub's account based on measured usage creating a barter, trading, and exchange mechanism. This creates a direct economic incentive for early adoption of Hubs to develop and share high-quality, reusable assets, promoting collaboration and efficient resource sharing across the system that could be put on digital public rails. In the context of federated learning, the Governance Agent 316 handles token payouts based on contributions, potentially using metrics such as Shapley-value scores to quantify each Hub's contribution to the overall model improvement. The agent provides APIs for Hubs, agents, and operators to query token balances, transaction history, and resource pricing, ensuring transparency and accountability within the token economy.

Before approving a global workflow, the Governance Agent 316 computes a comprehensive benefit score that incorporates multiple factors, an exemplary calculation could be: Benefit=α*Policy_Compliance+β*Operational_Efficiency−γ*Token_Cost+δ*Tokens_Earned. This is exemplary approach for benefit assessment and tokenization. This calculation allows for nuanced decision-making that balances regulatory compliance, operational performance, resource consumption, and collaborative contribution but could be expanded to many other quantification approaches. This could include proof of stake and proof of work approaches for ensuring water quality and damage prevention from water and environmental infrastructure. Other approaches could include accuracy, computational cost, ‘likes or approvals received’, etc.

Beyond economic management, the Governance Agent 316 also oversees system-wide policy enforcement. It monitors system components and agent behavior for compliance with global rules related to data privacy, security protocols, operational limits, and resource quotas. The agent can implement graduated enforcement mechanisms, ranging from warnings and temporary restrictions to complete isolation of non-compliant components, depending on the severity and persistence of violations. The Governance Agent 316 plays a key role in self-evolution safety guardrails, maintaining a model lineage graph and requiring any agent mutation or new policy to pass counterfactual replay tests generated by the Scenario Forge before deployment. The Governance Agent 316 leverages Architecture Oversight capabilities, using System Connection Memory 780 to understand and optimize the overall system architecture in conjunction with economic factors and policy goals. This allows for continuous refinement of the system structure to better align with evolving requirements, constraints, and operational patterns. Furthermore, the Governance Agent 316 can adapt the frequency of federated learning aggregation rounds based on global Memo drift signals received from Hubs, ensuring that model updates are triggered when and where they are most needed across the system.

In certain embodiments, the Nexus Supervisory Pentad includes two optional lightweight supervisors: the Archivist 318 and the Risk Officer 319. The Archivist 318 functions as a long-term memory curator, responsible for tasks such as deduplicating experience traces, compressing data into train/test splits, and tagging rare-event slices from the system's operational history. It can expose an “exemplar-replay API” allowing Hubs to pull stratified batches of experience for local fine-tuning or testing. The Risk Officer 319 acts as a real-time safety monitor, running an independent model of hazardous states (e.g., predicting hydraulic surges or toxic releases) and holding an emergency override token; it can issue global commands, such as a “freeze AP class X” command, to halt or modify agent behavior in critical situations. These optional roles can be loaded as plug-ins or have their functions collapsed into the primary Trio agents depending on the deployment's scale and complexity requirements. The Nexus Supervisory agents 310 function as a coordinated unit that manages semi-autonomous Task Agents through a vote-and-token governed process and orchestrates system-wide learning and evolution. This supervisory approach ensures that agents stay on mission, evolve safely, and share compute resources fairly across the entire multi-utility environment. The tight coupling between agent creation, operational coordination, and resource governance, along with the integration of specialized roles for data curation and safety monitoring in expanded embodiments, creates a self-regulating ecosystem that can adapt to changing conditions while maintaining alignment with overall system objectives and constraints. By providing a formalized framework for resource sharing and collaboration, the Nexus Supervisory Trio enables water/energy/transportation utilities to leverage each other's expertise and resources while maintaining appropriate boundaries and ensuring fair compensation for contributions. Supervisors can be implemented in separate Kubernetes namespaces, each potentially having a dedicated etcd instance to sandbox policy edits. Policy modules can be implemented using technologies such as WebAssembly (Wasm) plug-ins for hot-swappable policy updates without requiring pod restarts. Inter-supervisor communication can utilize gRPC-streams with flexible data formats like protobuf Any to allow for schema-free metric expansion. Key API interactions and data streams between supervisors support their coordinated functions, such as the Sheepdog's/vote and/global-memo streams, the Creation Agent's/forge endpoints, the Governance Agent's/token and/policy APIs, and the Archivist's and Risk Officer's respective data offering and hazard alerting streams.

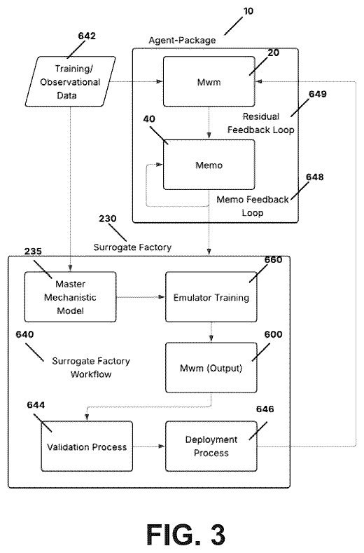

Referring now to FIG. 3 which illustrates the continuous, feedback-driven Surrogate Factory workflow, showcasing the automated process for generating, training, validating, packaging, and deploying computationally efficient physics-surrogate World Models (Mwms). The figure details the inputs to the factory, including the Master Mechanistic Model (MMM) as ground truth, observational/training data, and crucial operational feedback streams such as prediction residuals (Residual feedback loop 649) and Emotion Tensor (Memo) metrics (Memo feedback loop 648) from deployed Agent-Packages (APs). It highlights how Memo signals prioritize retraining and model improvement efforts.

Further, the Learning and Calibration Loop mechanism of the system is described in detail. This mechanism establishes a continuous, automated process for improving the accuracy and relevance of both the Master Mechanistic Model (MMM) 235 and the computationally efficient World Models (Mwms) 20 deployed within Agent-Packages (APs) 10 throughout the system hierarchy 100. Rather than relying on periodic, manual updates, the invention implements a closed-loop approach that leverages operational feedback and real-world data to drive continuous improvement across different model types and hierarchical levels.

The process begins with the operation of the Master Mechanistic Model (MMM) 235, which represents a high-fidelity, physics-based digital twin typically residing at the Hub level. The Master Mechanistic Model 235 itself is continuously re-calibrated using streams of operational data, including high-frequency sensor deltas, laboratory assay results, operator set-points, and other relevant measurements received from Nodes and Clusters. This calibration involves a dual loop process. A state-parameter estimation loop, potentially utilizing techniques such as Unscented Kalman Filters (UKF), Ensemble Kalman Filters, or adjoint gradient methods chosen based on process non-linearity, runs frequently (e.g., hourly) to update internal state variables and calibrate key kinetic, hydraulic, or sensor-bias parameters within the MMM 235. This real-time data-assimilation pipeline keeps the MMM 235 aligned with current operational reality. In an exemplary embodiment, this pipeline keeps a rolling window of recent data (e.g., the last 48 hours) for rapid state estimation and archives daily baselines with provenance hashes for historical analysis and model training. Updated snapshots of the calibrated MMM 235, reflecting the latest understanding of the physical system's parameters and state, then feed into the Surrogate Factory 230.

Concurrently, the Learning and Calibration Loop operates on the Mwms 20 deployed within APs 10. This loop begins with the execution of predictions or simulations by APs 10 deployed at various levels of the system hierarchy 100. These APs 10 leverage their embedded Mwms 20 to generate outputs about various aspects of water infrastructure operation (also energy and environment infrastructure). As these outputs are generated, and ground truth or validated data becomes available, the APs 10 calculate feedback signals, such as prediction residuals quantifying the difference between Mwm 20 outputs and observed values.

These feedback signals, along with relevant contextual information and the AP's Memo (especially dimensions related to Accuracy, Data Quality, Uncertainty, and Alignment Flag), are streamed back to the Surrogate Factory 230 at the Hub level. The streaming process typically employs efficient, low-overhead protocols to minimize bandwidth consumption, particularly for edge-deployed APs 10 that might operate in bandwidth-constrained environments. The feedback data is structured to include the input conditions that generated the Mwm 20 output, the output itself, the corresponding observed outcome, and appropriate timestamps and identifiers to ensure proper alignment and traceability. In certain embodiments, to conserve edge bandwidth, especially when network links are constrained (e.g., less than 64 kbps), residual uploads are compressed (e.g., with zstd), and only the top-k largest errors or most informative samples (e.g., weighted by TD-error or uncertainty) are sent per epoch (e.g., every 5 minutes). Similarly, parameter differences for MMM updates pushed to edge APs 10 are compressed, for example, as small Protobuf delta-patches (e.g., less than 2 kB).

Upon receiving this feedback data, the Surrogate Factory 230 uses the incoming Memo signals to prioritize its retraining or calibration queue. This prioritization mechanism represents a significant advancement over traditional update schedules, as it ensures that computational resources for model improvement are directed where they are most needed. Mwms 20 associated with APs 10 reporting significant prediction errors (for example, exceeding a threshold such as 10% root mean square error), poor data quality, high uncertainty, or significant alignment divergence are flagged for immediate attention, while models performing within acceptable parameters receive lower priority.

The retraining or calibration process itself leverages several key data sources: the streamed feedback data (curated and potentially re-sampled as described below) from deployed APs, the original training data 642 used to create the initial model, and the updated snapshots of the Master Mechanistic Model 235 maintained at the Hub. By combining these data sources, the Factory can develop updated models that not only address observed discrepancies but also maintain physical consistency and plausibility informed by the latest calibrated MMM 235. When parameters in the Master Mechanistic Model 235 change significantly (e.g., by more than a threshold 8%), the Factory can be triggered to auto-queue a “light refresh” of affected Mwms 20, potentially using techniques like retraining only low-rank adapter (LoRA) heads or shifting bias layers to rapidly inherit the latest physics without full retraining.

Depending on the nature and extent of the model drift or the type of update triggered, the Factory may implement different update strategies. Full retraining involves completely rebuilding the model using the expanded dataset, which provides the most comprehensive update but requires significant computational resources. Incremental fine-tuning, in contrast, adjusts specific model parameters to address observed discrepancies while retaining the overall structure and most parameters of the existing model. This approach is particularly useful for addressing localized drift without disrupting overall model performance. Lightweight updates, often triggered by specific Memo drift patterns or MMM 235 parameter changes, may focus on adapting only certain layers or components of the model to address specific issues efficiently.

In certain embodiments, the data stream used for Mwm 20 training incorporates experience-weighted re-sampling. Samples from the residual stream are weighted by metrics such as TD-error or uncertainty to favor informative cases during training, which can reduce training cost by approximately 50% while improving learning efficiency. A stratified buffer is maintained, containing slices of data categorized as routine, abnormal, or extreme events, to ensure balanced mini-batches during training and improve model robustness across diverse operating conditions.

Once a new version of the Mwm 20 is trained, it undergoes rigorous validation to ensure that it indeed improves upon the previous version. This validation typically involves testing the model against held-out data not used in the training process, comparing its performance to the current deployed version, and potentially evaluating it against specific challenging scenarios known to be important in the operational context or generated synthetically by the Scenario Forge. Only models that demonstrate clear improvement and pass safety benchmarks are approved for deployment.

Approved models are then packaged and securely deployed back to the relevant APs 10 in the field, replacing the older versions. This deployment process 646 leverages the hot-swap portability feature described previously, allowing for seamless model updates without disrupting ongoing operations. The system maintains detailed lineage tracking for learning artifacts. Information such as the model identifier (model_id), the ID of the Master Mechanistic Model 235 snapshot used for training (mmm_snapshot_id), identifiers for the data slices used (data_slice_id), and the relevant version control commit (git_commit) are stored in a Model Registry. This ensures that the system maintains a clear record of model lineage and provenance. An API, for example accessible via/lineage/{model_id}, is provided for audit and rollback purposes, allowing retrieval of the complete history and dependencies of any deployed model version. Furthermore, before Mwms 20 are deployed, particularly those intended for control tasks, they are run through a safety and alignment testbed. This involves replaying the candidate Mwm 20 against hazard benchmarks embedded in the Master Mechanistic Model 235 to ensure the new policy or model does not breach critical operational or safety constraints.

The Learning and Calibration Loop operates at multiple time scales to address different types of model drift and learning objectives. In an exemplary multi-timescale scheduling framework, various loops operate with different cadences and triggers:
MMM state update: Typically runs every 15 minutes to 1 hour, triggered by new sensor batches, to update ODE/PDE state variables based on real-time data assimilation.
MMM parameter calibration: Occurs every 6 hours to daily, triggered when the rolling RMSE exceeds a threshold (τ1), to calibrate kinetic, empirical, or sensor-bias parameters.
Mwm 20 micro-tune (edge): Runs per approximately 1000 inferences or continuously, triggered by Memo.acc drift exceeding a threshold (τ2), to perform lightweight updates (e.g., to the last adapter layer) on device.
Factory light retrain: Scheduled nightly or triggered by significant MMM parameter changes, focusing on updates such as LoRA head retraining or bias-layer shifts.
Factory full retrain: Scheduled weekly or triggered by systemic error or drift exceeding a threshold (τ3), involving retraining of the entire network using accumulated data.
This multi-timescale approach ensures that the system can respond quickly to emerging issues while also undertaking more thorough improvements when appropriate.
The system incorporates active-learning feedback loops to generate informative training data 642. When an AP 10 flags an “unknown regime,” for example, when its prediction uncertainty (Memo.Uncertainty) exceeds a threshold (τ4), the Sheepdog can be notified. The Sheepdog can then direct the Creation Agent 314 to spawn a “probe scenario” within the Master Mechanistic Model's 235 simulation environment. This generates synthetic data specifically for the conditions flagged as uncertain, and this synthetic data is then returned to the Surrogate Factory 230 to train or fine-tune affected Mwms 20, thereby reducing uncertainty in those regimes.

A particularly valuable aspect of this mechanism is its ability to focus learning efforts on areas demonstrating drift or poor performance. Rather than updating all models uniformly, the system directs computational resources and expertise where they will have the greatest impact. This targeted approach has demonstrated significant benefits in testing environments, with improvements in Mwm 20 accuracy of approximately 18% after 30 days of operation without human intervention, as the system automatically identified and addressed the most significant model deficiencies.

The Learning and Calibration Loop extends beyond individual Hub environments through the Nexus layer's 110 coordination capabilities. When multiple Hubs encounter similar issues or when improvements developed in one Hub might benefit others, the Nexus Supervisory Trio facilitates knowledge sharing and model enhancement across domains. The Creation Agent 314 can extract generalizable improvements from Hub-specific updates, incorporate them into broader model templates, and distribute them to other Hubs where they might be beneficial, potentially triggering token transactions through the Governance Agent's economy.

This continuous, feedback-driven improvement process ensures that the system's predictive and control capabilities remain accurate and relevant despite changing conditions, evolving infrastructure, or emerging operational patterns. By establishing automated mechanisms for model refinement and data assimilation that leverage real-world performance data, synthetic scenarios, and multi-scale feedback, the invention overcomes a significant limitation of traditional digital twin systems, which often suffer from growing inaccuracy over time as conditions diverge from those present during initial development.

The Learning and Calibration Loop also contributes to system transparency and explainability by maintaining clear records of model updates, the data driving those updates, their lineage, and the resulting performance improvements. This documentation supports regulatory compliance, operational confidence, and continuous system refinement. Through this robust, adaptive learning approach, the system maintains its predictive accuracy and relevance over extended operational periods without requiring constant human oversight or manual recalibration, significantly reducing maintenance burden while improving overall performance.

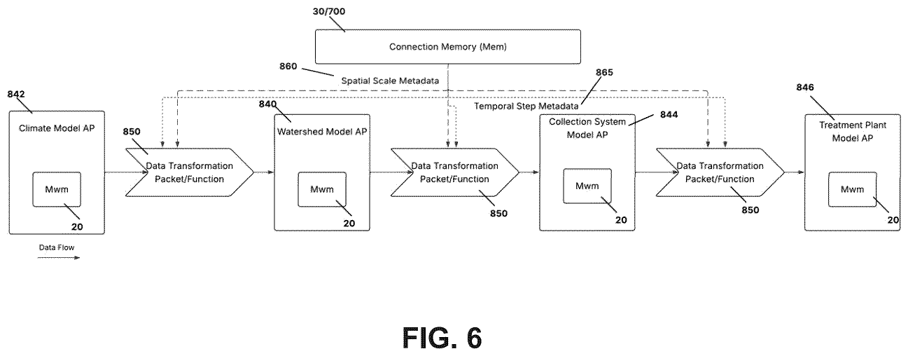

Referring now to FIG. 2 and FIG. 6, representative use-cases of the system are described in detail to illustrate the practical application and benefits of the invention across various water infrastructure domains (also energy and environment infrastructure domains). These use-cases demonstrate how the hierarchical agent architecture, with its integrated core components and sophisticated orchestration and learning capabilities, addresses real-world challenges in water resource management by enabling advanced monitoring, prediction, analysis, optimization, decision support for operators, and in certain configurations, a degree of autonomous operation and control.

Specifically, FIG. 6 shows a representative multi-scale model interaction example, illustrating how the Hierarchical Digital-Twin System seamlessly integrates and mediates between models operating at vastly different spatial scales and temporal steps (e.g., a Climate Model AP, Watershed Model AP, Collection System Model AP 844, Treatment Plant Model AP 846). The figure demonstrates how the hierarchical Connection Memory (Mmem) facilitates the discovery of compatible models and the application of necessary Data Transformation Packets/Functions 850 (like unit or scale conversions) to enable comprehensive cross-scale analysis and predictive foresight without requiring bespoke integration code.

In exemplary wastewater treatment applications, the system provides significant predictive and optimization capabilities. For example, the system can predict effluent quality violations hours or days in advance by deploying APs 10 that continuously monitor influent characteristics, process parameters, and operational conditions. These APs 10 leverage their embedded Mwms 20 to simulate the progression of wastewater through treatment processes, identifying potential compliance issues before they occur. When a potential violation is detected, the system can notify operators with sufficient lead time to implement corrective measures, potentially preventing regulatory violations and associated penalties. Beyond prediction and alerting, the system can also identify optimal process setpoints (e.g., chemical dosing, flow distribution) to proactively avoid predicted violations, optimizing system performance against operational objectives, and in certain embodiments, can be configured to autonomously implement these optimal setpoints.

The system also enables optimization of aeration blower setpoints based on predicted dissolved oxygen (DO) levels and energy costs. By integrating real-time sensor data, operational contexts, and energy pricing information, the system can identify optimal blower settings that maintain adequate DO levels for biological processes while minimizing energy consumption. This optimization considers factors such as diurnal load variations, temperature effects on oxygen transfer efficiency, and biological oxygen demand patterns, resulting in significant energy savings while maintaining treatment performance, with the system learning to refine its optimization strategies based on real-world energy consumption and process data. This capability supports operator decision-making, and in embodiments configured for direct control, allows the system to learn and execute control strategies for autonomous optimization of aeration. In certain embodiments, an AP 10 can use its embedded Mwm 20 to perform rapid on-device planning, simulating the outcome (e.g., predicted DO trajectory and energy cost) of several potential blower adjustments before recommending or implementing the optimal action.

Furthermore, the system facilitates simulation of operational changes through natural language queries. For instance, an operator might ask, “Simulate DO levels if blowers are reduced by 10% for two hours.” The Request/Response Processing Agent 224 interprets this query, the Orchestration Agent designs and executes a simulation workflow, and appropriate APs 10 perform the necessary calculations using their Mwms 20. The results are then presented to the operator in an accessible format, potentially including predicted DO trajectories, impacts on treatment performance, and energy savings estimates. This capability allows operators to evaluate operational changes before implementation, reducing risk and improving decision-making, and can also be used to generate synthetic training data 642 for the system's learning algorithms by simulating rare or challenging scenarios.

In stormwater management contexts (exemplary of widely variable system inputs/needs for environmental or energy systems), the system predicts combined sewer overflows (CSOs) based on weather forecasts and real-time sensor data. APs 10 deployed throughout the collection system monitor flow levels, precipitation data, and hydraulic conditions, while integrated surrogate models simulate the system's response to projected rainfall. When potential overflow conditions are identified, the system alerts operators and may suggest preemptive actions, such as adjusting flow control structures or activating storage facilities, to mitigate overflow risks. The system can also identify optimal strategies to coordinate distributed assets (e.g., pumps, gates, storage) based on predicted inflow and system state, optimizing operations to minimize overflow volume and flooding risk, and in certain configurations, can provide autonomous coordination of these assets.

The system also optimizes pump station operations during storm events by considering multiple factors simultaneously. These include predicted inflow rates, available storage capacity, downstream hydraulic constraints, energy costs, and equipment limitations. By coordinating pump operations across multiple stations through hierarchical orchestration, the system can identify operational strategies to maximize system capacity utilization while minimizing flooding risks and operational costs, with the system continuously learning to refine these strategies based on operational data. This learned optimization supports operator recommendations and can also enable autonomous control of pump schedules in suitable deployments.

For water distribution applications (exemplary of linear energy (such as energy/telecommunication lines or cables) or environmental infrastructure, the system demonstrates capability in localizing potential leaks or pipe bursts (breaks in linear infrastructure) based on pressure and flow anomalies. APs 10 monitoring distribution network sensors analyze patterns that might indicate developing leaks, using their Mwms 20 to distinguish between normal operational variations and actual leak signatures. The system's multi-scale modeling capabilities enable it to consider both local hydraulic conditions and broader network effects, improving detection accuracy and reducing false alarms. Upon detecting a leak or burst, the system could potentially suggest localized actions (e.g., valve adjustments) to minimize water loss or isolate the issue, leveraging planning capabilities within the Mwm 20 to evaluate potential outcomes of different sequences of actions. In scenarios where autonomous response is configured and appropriate safety protocols are met, the system can also be enabled to autonomously execute localized actions to manage leak or burst impacts.

The system also predicts water quality issues, such as disinfection byproduct formation, in different parts of the network. By integrating water quality models with hydraulic simulations and considering factors like water age, temperature, organic matter content, and disinfectant residuals, the system can identify locations and conditions with elevated risk. This predictive capability allows operators to implement preventive measures, such as adjusting disinfection practices, flushing specific sections, or modifying operational patterns to minimize byproduct formation while maintaining disinfection effectiveness. The system can also identify optimal strategies to optimize disinfection setpoints or flushing schedules based on predicted water quality and defined objectives that incorporate compliance requirements and chemical costs, learning to refine these strategies based on operational feedback. This learning capability enables the system to provide highly refined recommendations or, in autonomous configurations, directly adjust setpoints for optimized water quality management. In certain embodiments, an AP 10 can flag an “unknown regime” if prediction uncertainty is high in a specific area, triggering an active learning process where the system generates a synthetic scenario in the Master Mechanistic Model 235 to create training data 642 for that condition.

A particularly valuable application is cross-utility or cross-domain collaboration. The system facilitates sharing of validated Mwms 20 and learned operational strategies or model updates for common processes, such as pump energy consumption models or aeration control strategies, between different water utilities (exemplary). This sharing is coordinated through the Nexus layer 110, potentially involving token exchange via the Governance Agent 316 to incentivize contribution and fairly compensate resource providers. By leveraging the collective experience and data and learned strategies from multiple utilities, the system enables more robust and generalizable models and more effective operational strategies than would be possible with single-facility data alone. This mechanism supports federated learning, allowing insights gained from the operational experience of one utility to improve models used by others while respecting data privacy boundaries.

The platform mediates cross-scale interactions by storing every model-hosting agent (or functional transform packet) as a vertex in Connection Memory (Mmem) 30, which is implemented as a property graph 790. Each vertex is annotated with explicit metadata-spatial scale (e.g., “100 km grid,” “sub-catchment,” “plant-influent pipe”), temporal step, state-vector names with engineering units, and a pointer to any input-output (I/O) transform packet capable of reconciling mismatches. Because these descriptors live in the graph, the Hub-level orchestrator can issue a single declarative query to discover a chain of compatible models and transforms whenever a cross-scale request arrives. Consider a storm-driven nutrient-surge scenario. A climate-model AP 10 publishes a NetCDF rainfall field on a 100 km grid with a three-hour step. Mmem 30 already records that this variable “precip_mm_h” needs bilinear re-gridding and temporal interpolation before it can feed any watershed model (exemplary, also applies to airshed/energyshed) expecting a 1 km, fifteen-minute series. The planner follows the needs_transform edge to a functional packet registered as Interp-100 k→1 k. Upon execution, that packet emits an interpolated rainfall data set and—critically—creates a new feeds edge in Mmem 30 linking its output to the watershed AP. The watershed surrogate then produces nitrate loadings per sub-catchment, which Mmem 30 knows must be divided by hydraulic flow to yield concentration. Another transform packet, Load-to-Conc, is automatically selected because its vertex advertises both the required unit conversion (kg→mg) and a runtime pointer to the collection-system hydrograph stream. Finally, a treatment-plant influent AP 10 that declares “NO₃_mg_L” as a valid input is reached; the orchestrator adds a temporal-alignment tag (mean-15 min-to-1 min) to the connecting edge and launches the plant-level surrogate. Throughout this pipeline no hard-coded scripts are written. Compatibility is guaranteed because every edge in Mmem 30 carries a formal contract (units, grid, time step); schema validation blocks an execution if a contract is violated. Once a path is used, its provenance—source IDs, transform hashes, commit versions—is persisted, so future storm events re-use the same graph traversal and the orchestration latency collapses to milliseconds. By encoding scale, unit, and transform knowledge directly in tiered Connection Memory 30, the system delivers fully automated, auditable mediation of climate→watershed→collection→plant models, giving operators actionable foresight (e.g., an ammonia spike predicted six hours ahead) without bespoke integration engineering. This ability to seamlessly link models across scales is critical for enabling sophisticated analysis and optimization strategies, and supports the implementation of cross-scale control policies.

In advanced sensing applications, the system supports the deployment of APs 10 directly onto or in close integration with sophisticated sensor platforms and analytical apparatuses. This includes leveraging capabilities of systems such as modular, automated sampling, preparation, testing, and analysis devices. APs 10 deployed in this context can perform onboard data validation, anomaly detection, or local prediction by processing raw or pre-processed data streams from the analytical hardware. For example, an AP 10 integrated with a modular spectrophotometric analyzer could control sampling triggers (e.g., based on predictive insights or operational events), manage sample preparation steps (like automated dilution or reagent addition), initiate specific tests (e.g., rate tests like SNR or SDNR), and process the resulting spectral or concentration data. Furthermore, the AP 10 can influence or modify the control parameters or logic of the integrated hardware platform itself, based on real-time analysis, predictive outputs, or its Memo status, enabling adaptive and optimized analytical performance. The AP 10 could use its embedded Mwm 20 to interpret complex spectral data (e.g., convert absorbance spectra into constituent concentrations), simulate the analytical process itself, or utilize the high-quality analytical results to calibrate other online sensors (such as ISEs), thereby reducing data transmission needs and enabling rapid, intelligent response to changing conditions. This capability extends to identifying optimal local strategies for the analytical hardware, optimizing sampling frequency, test parameters, or preparation steps based on real-time data streams, Mwm predictions, and defined objectives (e.g., maximizing data quality while minimizing reagent consumption), with the system learning to refine these strategies. In certain deployments, this learning can enable a degree of autonomous optimization and control of the integrated analytical hardware.

The system provides sophisticated operator interaction capabilities through natural language interfaces 914. Operators can interact with the system using conversational queries such as “Generate a report on pump station X performance last week,” “Show me areas with predicted high leak risk,” or “What is the predicted flow at point Y in 6 hours?” The Request/Response Processing Agents 224 handle the interpretation of these queries, coordinating with Orchestration Agents 210 and relevant APs 10 to gather and analyze the necessary data, and then generate appropriate responses. These might include textual summaries, data visualizations, or structured reports tailored to the operator's needs and presented in the most suitable format-whether dashboard display, mobile device notification, or printable document. Operators can also inquire about the system's recommended actions or the rationale behind optimization suggestions, leveraging the interpretability features of the Mwms 20 and the provenance tracking in the Mmem 30. Furthermore, the interface can facilitate configuration of autonomous control modes or provide visibility into the system's autonomous actions when enabled.

The system's advantages extend to operational planning and scenario analysis. For example, operators might use the system to evaluate the potential impacts of planned infrastructure upgrades, changes in regulatory requirements, or shifts in service population. By simulating these scenarios using appropriate combinations of APs 10 and their Mwms 20, the system can provide quantitative projections of performance, resource requirements, and compliance implications, supporting informed decision-making and strategic planning. This includes simulating the performance of different operational strategies or generating training data 642 for learning algorithms. Maintenance optimization represents another valuable use-case. By analyzing equipment performance data, operational patterns, and failure histories, the system can recommend maintenance schedules that balance risk reduction with resource efficiency. The Memo-driven health monitoring capabilities are particularly valuable in this context, allowing early detection of performance degradation or anomalous behavior that might indicate developing issues before they result in failures or operational disruptions.

Furthermore, the system can identify optimal proactive maintenance strategies based on predicted failure probability (from Mwm/Memo analysis) and the real-world costs of planned vs. unplanned maintenance, optimizing maintenance schedules and resource allocation to minimize overall operational expense and downtime. This capability supports recommendations for maintenance activities and can inform autonomous maintenance scheduling systems where integrated.

Through these diverse applications across wastewater treatment, stormwater management, water distribution, cross-domain collaboration, advanced sensing, and operator interaction, the system demonstrates its versatility and value in addressing the complex challenges of modern water infrastructure management (also other infrastructure). By providing timely, accurate, and contextually relevant insights, and by identifying optimal operational strategies based on real-world outcomes, the system enables more efficient operations, improved regulatory compliance, reduced resource consumption, and enhanced decision-making across the water infrastructure lifecycle, and supports the implementation of autonomous control capabilities where appropriate and configured.

Referring now to FIG. 2, the technical effects of the present invention are described in detail. The architectural components and methodologies described herein provide several concrete and measurable technical effects that significantly enhance the capabilities, efficiency, and effectiveness of water infrastructure (exemplary of other infrastructure) monitoring and management systems.

One primary technical effect is Memo-Steered Task Routing, which leverages real-time agent health and performance metrics for dynamic task allocation. By continuously monitoring the Emotion Tensor (Memo) 40 of deployed APs 10, orchestration components can intelligently route computational tasks to the most suitable execution environments based on current conditions rather than static assignments. This stems from the system's ability to avoid routing tasks to overloaded or underperforming agents, instead selecting those with optimal combinations of low prediction error, available computational resources, and high-quality data inputs. The dynamic routing also enhances system resilience by automatically adapting to component failures or performance degradation without requiring manual intervention.

Residual-Guided Retraining represents another significant technical effect, where the system continuously improves Mwm 20 accuracy through feedback-driven calibration prioritized by Memo signals. Rather than applying uniform retraining schedules across all models, the system focuses computational resources on models demonstrating the greatest accuracy drift or performance issues. The continuous nature of this improvement process ensures that the system maintains or enhances its predictive capabilities over time, even as operational conditions evolve or underlying physical processes change.

The Token Pricing of Resources mechanism produces substantial technical effects in multi-entity or distributed environments. By implementing a formalized economy for resource accounting and exchange, the system reduces contention and improves overall efficiency. This improvement stems from the economic incentives created by the token system, which encourages more efficient resource utilization and promotes collaboration through fair compensation for shared capabilities. The token economy also enhances system governance by providing transparent mechanisms for resource allocation, contribution tracking, and value exchange among participating entities.

The Tiered Mmem 30 Routing capability delivers significant technical effects in terms of integration efficiency and engineering effort reduction. The hierarchical organization of connection memory enables streamlined composition of multi-scale models and integration of new data sources compared to traditional manual API stitching approaches. This efficiency gain allows the system to rapidly adapt to new requirements, incorporate emerging technologies, or extend its functionality without extensive redevelopment efforts. The standardized memory structures also promote consistency and reusability across different components and deployments, further enhancing development efficiency.

The Adaptive Edge Cognition enabled by the Tri-Tensor AP architecture produces measurable technical effects in terms of operational autonomy and responsiveness. By integrating World Models (Mwm) 20, Connection Memory (Mmem) 30, and Emotion Tensors (Memo) 40 within a single portable unit, APs 10 can make autonomous local decisions—including tool selection, prediction modulation, and goal escalation—without constant central coordination. This capability significantly improves system responsiveness, particularly in environments with limited connectivity or high latency.

Hot-Swap Portability of surrogate models provides technical effects related to system flexibility and maintenance efficiency. The ability to stream model binary files to new compute instances in seconds over low-bandwidth networks (for example, using MQTT) enables live migration of predictive capabilities when needed. This capability results in measurable improvements in system availability, with typical model migration times reduced from hours or days (in traditional deployment approaches) to seconds or minutes. The standardized manifest format and compatibility checking mechanisms ensure that migrations occur seamlessly without introducing version conflicts or incompatibilities, maintaining system integrity throughout the process.

On-Line Adaptation capabilities deliver technical effects in terms of model accuracy and adaptability to changing conditions. The ability of APs 10 to apply lightweight online learning techniques to their embedded Mwms 20 when accuracy drift is detected allows the system to maintain predictive performance despite evolving operational patterns or environmental factors. Testing has shown that these adaptation mechanisms can reduce prediction error by up to 30% in scenarios with significant concept drift, such as seasonal transitions or operational mode changes, without requiring full model retraining.

Multi-Scale Model Mediation facilitated by the tiered structure of the Connection Memory (Mmem) 30 produces technical effects related to comprehensive analysis capabilities. By storing pointers and unit/scale metadata at each level of the memory hierarchy, the system enables efficient integration of models operating at different temporal and spatial scales—from climate models 842 spanning decades and continents to process models operating at second-by-second timescales within specific equipment units. This capability has demonstrated concrete benefits in scenario analysis applications, reducing analysis preparation time by up to 85% for complex cross-scale scenarios such as climate change impact assessments on treatment plant operations.

Natural Language Interaction capabilities enabled by the Interface Connection Memory 760 and Request/Response Processing Agents 224 produce technical effects in terms of operational accessibility and reduced training requirements. By allowing operators to interact with the system using conversational language rather than specialized query formats or complex graphical interfaces, the system significantly reduces the expertise barrier for accessing advanced analytical capabilities.

The combined effect of these technical capabilities is a water infrastructure management system (exemplary system) that delivers demonstrable improvements in predictive accuracy, operational efficiency, resource utilization, integration flexibility, and user accessibility compared to prior art approaches. These improvements translate directly to practical benefits for water/energy/transportation utilities, including enhanced regulatory compliance, reduced energy consumption, improved asset utilization, and more informed decision-making across operational and strategic timeframes.

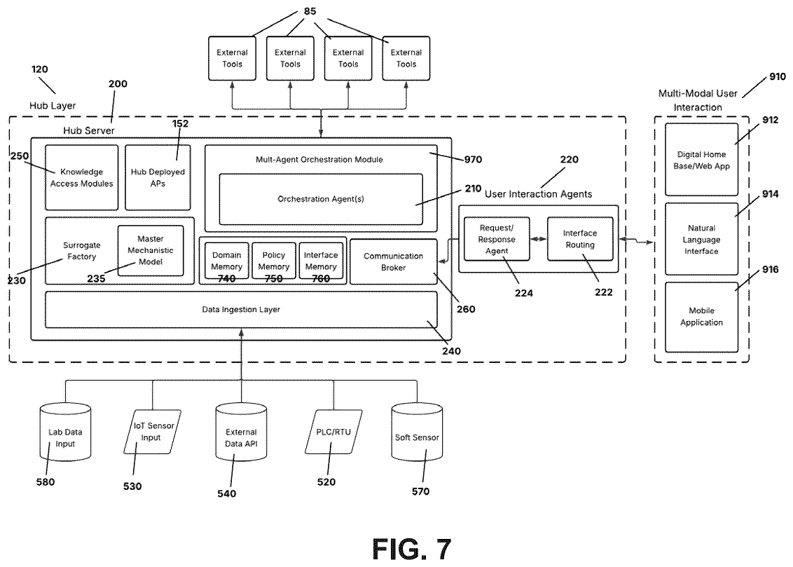

Referring now to FIG. 1 and FIG. 7, the enablement specifics of the present invention are described in detail. This section provides concrete implementation details that enable the functionality described throughout the specification, ensuring that the invention can be practically realized and operated by those skilled in the art.

Specifically, FIG. 7 provides a detailed view of the Hub architecture, depicting its central role and key functional components hosted on the Hub Server 200. It shows the Orchestration Agents managing task distribution, the User Interaction Agents handling multi-modal user interfaces including natural language processing, the Surrogate Factory for Mwm management, the Data Ingestion Layer 240 for multi-source data fusion, Knowledge Access Modules 250, Communication Brokers 260, and their interconnections, highlighting the Hub's role as the domain's operational nerve center managing Hub Deployed APs.

The Memo 40 calculation, as outlined in Section 5.4, is implemented through specific formulas and methodologies. For the Accuracy dimension, the AP 10 calculates a rolling Root Mean Square Error (RMSE) over the last k predictions compared to ground truth or validated data. This calculation is expressed as:

$$Accuracy = sqrt ( sum ( {( predicted\_i - actual\_i )}^{2} ) / k )$$

where predicted_i represents the i-th prediction value generated by the AP's Mwm 20, actual_i represents the corresponding observed value, and k is the number of prediction-observation pairs included in the calculation window. The window size k may vary based on the specific application, with typical values ranging from 20 to 100 points, chosen to balance responsiveness to recent performance changes with stability against outliers or transient conditions.
For the Load dimension, a weighted sum of resource utilization metrics is employed:

$$Load = w 1 * CPU \% + w 2 * RAM \% + w 3 * I / O\_wait$$

where CPU % represents the percentage of CPU capacity currently utilized, RAM % represents the percentage of available memory in use, I/O_wait represents the percentage of time spent waiting for input/output operations, and w1, w2, and w3 are weighting factors that reflect the relative importance of each resource constraint in the specific deployment context. These weights may be adjusted based on the hardware characteristics of the deployment environment, with typical values being w1=0.5, w2=0.3, and w3=0.2 for general-purpose edge computing platforms.
The Data Quality dimension is typically (exemplary) calculated as:

$$Data Quality = Valid\_samples \_received / Expected\_samples$$

where Valid_samples_received represents the count of data points that pass validation criteria (such as being within expected ranges, having appropriate timestamps, and not exhibiting suspicious patterns), and Expected_samples represents the anticipated number of data points based on known sampling frequencies and the time period being evaluated. Additional data quality metrics may be incorporated, such as signal-to-noise ratios for analog sensors or checksum validation rates for digital communications.

The implementation of the Mmem 30 using a property-graph database enables efficient storage and querying of complex relationship patterns. Specifically, databases such as Neo4j or JanusGraph are utilized, with nodes representing entities (agents, data sources, models, tools) and edges representing relationships between these entities. Both nodes and edges can have properties that describe their characteristics. This structure allows for expressive queries using languages like Cypher. For example, an AP 10 seeking to identify available tools with specific performance characteristics might execute a query such as:

$$MATCH ( me ) - [ ] -> ( tool ) WHERE tool . latency < 50 ms RETURN tool$$

where me represents the querying AP, CAN_CALL is a relationship type indicating tool accessibility, and the WHERE clause filters for tools meeting specific latency requirements. Similarly, an Orchestration Agent 210 seeking to identify APs 10 capable of predicting ammonia levels might use a query like:

$$MATCH ( ap ) - [ ] -> ( cap )$$

WHERE cap.type=‘prediction’ AND ‘ammonia’ IN cap.parameters
AND ap.memo.accuracy <0.1

### RETURN ap

This query identifies APs 10 with prediction capabilities specific to ammonia and with acceptable accuracy scores in their Memo. In certain embodiments, the Mmem 30 is implemented as a streaming temporal knowledge-graph supporting event-sourced updates, vector/symbolic fusion with embedding fingerprints (e.g., using FAISS or pgvector), built-in graph reasoning (e.g., executable edge attributes, GNN services), privacy controls (e.g., per-edge visibility), and auto-pruning mechanisms.

The Orchestration Decision Logic is implemented through rule-based or learning-based policies for task routing based on Memo scores. A common approach employs a weighted scoring function:

$$Score = w 1 * ( 1 - Accuracy ) + w 2 * Load + w 3 * Latency$$

where Accuracy, Load, and Latency are normalized dimensions from the AP's Memo, and w1, w2, and w3 are weighting factors. Tasks are assigned to the AP 10 with the minimum Score below a defined threshold; otherwise, they fall back to Hub execution or are re-routed. This scoring approach balances prediction quality with computational efficiency and responsiveness, ensuring that tasks are allocated to the most suitable execution environment given current conditions.

The Token Ledger 350 implementation utilizes either a permissioned distributed ledger technology such as Hyperledger Fabric or a centralized, cryptographically signed SQL ledger. Each transaction, whether a resource usage debit or a token earning credit, is signed by the Governance Agent's private key to ensure authenticity and non-repudiation. AP OCI image hashes or workflow definitions are stored as ledger metadata associated with contributed resources, providing a secure and verifiable record of resource provenance and utilization. The ledger schema typically includes tables for token balances, transaction history, resource contributions, and usage records, with appropriate indexing to support efficient querying and reporting.

Multi-Scale Mediation Pipelines are implemented using standardized data adapters and event triggers. For example, when a Hub Orchestrator publishes watershed (exemplary, also airshed and energyshed) model output as a NetCDF file, a downstream plant AP 10 may subscribe to an event trigger on_new_netcdf for that file. Upon notification, the AP 10 uses a standard adapter library such as Xarray to load and process the NetCDF data, extracting relevant variables and transforming them into the appropriate format for its Mwm 20 inputs. This standardized approach eliminates the need for custom integration code for each new data source or model combination, significantly reducing development effort and maintenance complexity.

The Natural-Language Agent Flow within the Request/Response Processing Agent 224 follows a specific pipeline implementation. Intent Classification is performed using a machine learning model, typically a BERT-based classifier or similar transformer architecture, trained to categorize user queries into functional categories such as “simulate what-if,” “generate report,” “query status,” or “optimize operation.” Entity Extraction then identifies key elements in the query, such as specific assets, time periods, or parameters of interest, using named entity recognition techniques. A query like “Show me dissolved oxygen levels in aeration basin 3 from last Tuesday” would be parsed to extract [parameter=dissolved oxygen], [asset=aeration basin 3], and [time=last Tuesday].

Following entity extraction, the agent performs Knowledge Retrieval using Retrieval-Augmented Generation (RAG) or similar techniques to access relevant context from the system's knowledge base. This might include retrieving standard operating procedures for the identified asset, historical data schemas for the parameter, or typical value ranges and patterns. Based on the identified intent, entities, and retrieved knowledge, the agent constructs a formal execution Plan Assembly, formulating an Mgoal that specifies the necessary data sources, analytical operations, and output formats. This Mgoal is then transmitted to the Orchestration Agent 210 for execution by relevant APs 10 through Orchestration Interaction.

Once results are received from the Orchestration Agent 210, the Request/Response Processing Agent 224 performs Response Generation, converting the analytical outputs into a format appropriate for the user's needs. This might include generating a Markdown-formatted text summary, creating inline PNG charts from returned data, or compiling a structured report using predefined templates. The agent selects the appropriate response format based on the user's interface context (dashboard, mobile app, conversational interface) and the nature of the results.

Container Portability is enabled through the packaging of APs 10 as Open Container Initiative (OCI) images that include all necessary dependencies. Each AP image incorporates a side-car container or probe that detects available hardware at the deployment location, such as GPUs or specialized neural processing units. Based on this detection, the AP 10 configures itself to utilize the most appropriate computational resources, falling back gracefully to CPU execution if accelerators are unavailable. This approach ensures that APs 10 can be deployed across diverse hardware environments without manual reconfiguration, enhancing system flexibility and scalability.

The Surrogate Feedback Loop implementation involves the continuous streaming of [input, prediction, truth] triples and Memo signals from deployed APs 10 to the Surrogate Factory 230. The Factory's training infrastructure incorporates online incremental fine-tuning processes that can be triggered by specific conditions, such as accumulated error exceeding predefined thresholds or detection of systematic bias in predictions. These fine-tuning operations can be scheduled as nightly jobs or executed on demand, applying techniques such as Elastic Weight Consolidation to update model parameters while preserving previously learned capabilities. The updated models are versioned and digitally signed before redeployment via automated mechanisms, such as Helm charts in a Kubernetes environment, ensuring secure and consistent updates across the system. The Surrogate Feedback Loop also incorporates continuous re-calibration of the Master Mechanistic Model 235 via a real-time data assimilation pipeline, experience-weighted re-sampling, stratified data buffers, multi-timescale scheduling, learning artefact lineage tracking, active-learning feedback loops, edge bandwidth guards, and a safety and alignment testbed for pre-deployment validation.

Communication between system components is implemented using standardized protocols and security measures. he system utilizes a uniform semantic layer (e.g., MCP/A2A) that can be transmitted over various transport protocols 960 depending on link robustness and bandwidth constraints, including gRPC or MQTT over TLS for robust links, DDS-XRCE for ultra-low-bandwidth or intermittent connections, and mesh network overlays like BLE or Wi-SUN for scenarios where backhaul connectivity collapses. Within the Hub's Kubernetes cluster, microservices communicate using gRPC over mutual-TLS, with schemas versioned in a central registry. For communication with edge-deployed APs, MQTT with TLS encryption is commonly employed, providing efficient pub/sub messaging with quality-of-service guarantees appropriate for potentially intermittent connections. Larger binary transfers, such as model updates or historical data batches, may utilize Kafka with exactly-once delivery semantics to ensure integrity. All communication channels implement appropriate authentication and authorization mechanisms, typically leveraging OAuth tokens with short lifespans and hardware-backed signing capabilities where available.

These detailed implementation specifics provide concrete mechanisms for realizing the functional capabilities described throughout the specification. By combining established technologies such as property-graph databases, container orchestration, machine learning frameworks, and secure communication protocols with the novel architectural components and methodologies of the invention, a practically deployable and operationally effective water infrastructure management system (exemplary system of other infrastructure) is enabled. These implementation details ensure that the invention can be realized by those skilled in the art, while the architectural innovations described provide significant advancements over prior approaches in terms of functionality, efficiency, adaptability, and scalability.

Referring now to FIG. 1 and FIG. 2, additional differentiating features of the present invention beyond the core tri-tensor AP and hierarchical architecture are described in detail. These features further enhance the system's capabilities, flexibility, and operational effectiveness in water infrastructure management applications (exemplary).

Container Portability represents a significant differentiating feature of the invention. APs 10 are packaged as Open Container Initiative (OCI) images, which include all necessary dependencies and runtime environments within a standardized, portable format. This packaging approach enables consistent deployment across diverse computing environments, from resource-constrained edge devices to powerful cloud platforms, without requiring environment-specific modifications. A particularly innovative aspect of this implementation is the inclusion of a side-car container or probe within each AP image. This component automatically detects available hardware resources at the deployment location, including specialized accelerators such as GPUs, TPUs, or FPGAs, as well as conventional CPU configurations.

Based on this hardware detection, the AP 10 dynamically configures itself to utilize the most appropriate computational resources for its embedded Mwm 20 execution. For example, if deployed to a cluster with available NVIDIA GPUs, the AP 10 might leverage CUDA acceleration for tensor operations, while the same AP 10 deployed to a basic edge computer would automatically fall back to CPU-only execution with appropriate quantization and optimization. This automatic adaptation eliminates the need for manual configuration or the maintenance of multiple AP variants for different hardware environments, significantly enhancing deployment flexibility and reducing operational complexity.

The container packaging also facilitates consistent versioning and update mechanisms. Each AP image is tagged with specific version identifiers, cryptographic signatures, and metadata describing its capabilities, resource requirements, and compatibility constraints. This information allows orchestration systems to make informed deployment decisions and verify the integrity and authenticity of deployed components. The standardized container format enables the use of established container orchestration platforms, such as Kubernetes, for managing AP 10 deployment, scaling, and lifecycle operations, leveraging industry-standard tools and practices for robust operational management.

The Surrogate Feedback Loop represents another significant differentiating feature that extends beyond basic model training capabilities. This mechanism establishes a continuous improvement cycle that keeps the system's predictive models aligned with evolving operational realities without requiring explicit human intervention. The feedback loop begins with deployed APs 10 streaming compact data packages back to the Surrogate Factory 230 at the Hub. These packages contain input-prediction-truth triples that document the AP's 10 predictive performance, along with contextual information and Memo signals that provide insights into operational conditions and data quality.

The continuous nature of this feedback enables an online incremental fine-tuning process that operates at multiple timescales. The Factory's trainer can run lightweight updates nightly or on specific triggers, addressing emerging prediction biases or performance issues promptly without disrupting ongoing operations. These updates typically focus on specific model layers or parameters identified as contributing to observed errors, using techniques such as Elastic Weight Consolidation (EWC) that preserve previously learned capabilities while adapting to new patterns. For example, if an AP 10 monitoring dissolved oxygen in an aeration basin begins to show systematic prediction bias during evening hours, the feedback loop might trigger a targeted update that adjusts specific model parameters related to diurnal patterns while preserving broader process understanding.

The feedback data is not only used for immediate model adjustments but also accumulated for periodic comprehensive retraining. This dual approach ensures that the system can respond quickly to emerging issues while also undertaking more thorough model improvements when sufficient new data has been collected. The Factory maintains versioning and provenance tracking for all model updates, creating a detailed lineage record that documents how each model evolved over time and the data that influenced each change. This tracking supports both regulatory compliance needs and technical diagnostics when investigating model behavior.

Updated models are packaged, versioned, and digitally signed before being deployed to relevant APs 10 via automated mechanisms, such as Helm charts in a Kubernetes environment or direct over-the-air updates for edge-deployed units. The deployment process 646 includes compatibility verification to ensure that updates do not disrupt ongoing operations, and rollback capabilities in case unexpected issues emerge after deployment. This comprehensive feedback and update mechanism enables the system to continuously improve its predictive capabilities while maintaining operational stability and security.

Alternative Mwm 20 implementations represent another differentiating aspect of the invention. While neural network-based surrogate models are commonly employed, the architecture supports diverse approaches to physics-surrogate implementation. Gaussian-process emulators provide an alternative approach particularly well-suited for scenarios with limited training data 642 or where uncertainty quantification is critical. These emulators use probabilistic methods to predict output distributions rather than point estimates, providing valuable insights into prediction confidence that can inform operational decision-making. For computational fluid dynamics (CFD) applications, such as clarifier flow patterns or mixing zone analysis, reduced-order CFD models derived through proper orthogonal decomposition or similar dimension-reduction techniques can be employed. These models preserve essential flow characteristics while dramatically reducing computational requirements, enabling real-time simulation of complex hydraulic processes.

Symbolic regression models represent another alternative implementation, particularly valuable for cases where interpretability is paramount. These models discover mathematical expressions that relate inputs to outputs, potentially revealing insights into underlying physical relationships that might be obscured in black-box approaches. The system's architecture accommodates these diverse Mwm 20 implementations within the same overall framework, allowing the most appropriate technique to be selected based on application requirements, data availability, and computational constraints.

Alternative Token Ledger 350 implementations provide flexibility in addressing different deployment contexts and security requirements. While a permissioned blockchain architecture using technologies like Hyperledger Fabric offers robust decentralized validation and immutable record-keeping, it may introduce overhead and complexity not warranted in all deployment scenarios. For environments where blockchain complexity is undesirable, the system supports implementation of the token ledger 350 as a centralized, cryptographically signed SQL database. This approach maintains essential integrity and non-repudiation properties through digital signatures and secure audit logging while reducing computational requirements and simplifying deployment architecture. The specific implementation can be selected based on the operational context, security requirements, and infrastructure capabilities of the deployment environment.

Alternative Orchestration Logic approaches enhance the system's adaptability to different operational patterns and optimization objectives. Beyond the rule-based scoring and allocation mechanisms described previously, the orchestration layer can employ reinforcement learning policies trained to optimize global objectives. These policies learn from historical task execution outcomes, developing sophisticated decision strategies that consider complex interactions and trade-offs not easily captured in explicit rules. For example, the orchestration logic might learn to preferentially route certain tasks to specific APs 10 during normal operations while developing different allocation patterns for high-load scenarios or emergency conditions. These learned policies can optimize for various objectives, such as minimizing latency, maximizing resource utilization, optimizing energy efficiency, or maximizing token earnings in multi-tenant environments. The training process for these policies typically employs simulated environments that model the system's behavior under various conditions, allowing extensive exploration and evaluation without affecting operational systems.

The communication backbone is anchored by the Model-Context Protocol (MCP) for hub-facing traffic and a lightweight Agent-to-Agent (A2A) schema for direct peer exchange. A key technical effect of this design is that both protocols expose identical semantic envelopes. This means that fundamental data structures representing sensor payloads, Mwm 20 handles, Memo tensors 40, provenance hashes, and Mgoals are consistently formatted, regardless of whether the message is traveling between two APs (A2A) or between an AP 10 and a Hub Orchestration Agent (MCP). This consistent semantic layer is critical for the efficiency and robustness of the orchestration layer. It allows the Hub and Nexus Orchestration Agents to parse any message type and understand its content without needing transport-specific or agent-specific parsing logic. Where links are robust, the payload rides on gRPC or MQTT over TLS; however, the same MCP/A2A envelope can be tunneled through DDS-XRCE when the platform is deployed at ultra-low-bandwidth or intermittently connected sites (e.g., solar-powered river gauges, LoRaWAN pump stations). DDS-XRCE's selectable quality-of-service profiles allow the orchestrator to tag Memo alarms as reliable/high-priority while streaming raw time-series as best-effort, guaranteeing that critical health data is delivered even over a 9.6 kbps link. If the back-haul collapses entirely, APs 10 switch to a mesh-network overlay—BLE or Wi-SUN, depending on hardware—using the same A2A envelope to maintain local consensus and share cached surrogate updates until the hub reconnects. This transport-agnostic, semantically consistent design means alternative cognitive embodiments inside an AP (tiny task-specific CNNs, rule-based engines, or hybrid neuro-symbolic stacks selected for resource-constrained hardware) can still advertise their capabilities and receive goals in exactly the same MCP format, preserving seamless orchestration and explainability across heterogeneous and challenging deployments.

Alternative AP 10 Embodiments provide flexibility in implementing the cognitive capabilities of deployed agents. While the primary implementation may utilize lightweight language models or joint-embedding predictive architectures for local inferencing, alternative approaches can be employed based on specific requirements or constraints. For edge deployments with severe computational limitations, the Cognitive Agent Logic 50 might utilize smaller, specialized neural networks trained for specific tasks, such as anomaly detection or pattern recognition, rather than more general-purpose models. In some cases, symbolic AI techniques, such as rule-based systems or decision trees, might be employed alongside or instead of neural approaches, particularly for well-understood domains with explicit operational rules or safety constraints. Hybrid approaches that combine neural components with symbolic reasoning can provide both the flexibility of learned representations and the transparency of explicit logic, enhancing explainability and trustworthiness in critical applications.

These additional differentiating features collectively enhance the system's flexibility, adaptability, and practical applicability across diverse and exemplary water infrastructure management scenarios. By supporting alternative implementations and approaches within a consistent architectural framework, the invention accommodates varying deployment contexts, operational requirements, and technological constraints while maintaining its core capabilities for intelligent, adaptive, and efficient water infrastructure management (exemplary).

Referring now to FIG. 1 and FIG. 2, alternative embodiments of the present invention are described to illustrate the flexibility of the core architectural concepts and their adaptability to diverse implementation contexts. The invention is not limited to the specific examples described in previous sections, and various alternative approaches may be employed while remaining within the scope of the disclosed principles.

Alternative Mwm 20 Implementations can extend beyond the neural network-based surrogates described previously to encompass a broader range of computational approaches. Gaussian-process emulators represent one such alternative, employing probabilistic methods to learn the mapping between inputs and outputs while inherently providing uncertainty quantification. These emulators excel in scenarios with limited training data 642 or where explicit confidence bounds are required for decision-making. The predictive distribution generated by Gaussian processes provides not just a point estimate but a complete probability distribution over possible outcomes, enabling risk-aware decision-making particularly valuable in regulatory compliance contexts.

Reduced-order Computational Fluid Dynamics (CFD) models offer another alternative implementation, particularly suited for hydraulic processes such as clarifier dynamics, mixing behavior, or flow distribution patterns. These models apply mathematical techniques such as proper orthogonal decomposition, dynamic mode decomposition, or discrete empirical interpolation to extract the most significant spatial and temporal patterns from high-fidelity CFD simulations. The resulting reduced-order models preserve essential flow characteristics while reducing computational complexity by several orders of magnitude, enabling real-time simulation of processes that would otherwise require hours or days of computation.

Symbolic regression represents a fundamentally different approach to surrogate modeling, focused on discovering explicit mathematical expressions that relate system inputs to outputs. Techniques such as genetic programming or sparse regression systematically explore the space of possible mathematical formulations, selecting those that balance accuracy with simplicity. The resulting expressions not only provide predictive capability but also potential insights into the underlying physical mechanisms governing system behavior. This approach is particularly valuable in contexts where interpretability and physical plausibility are paramount, such as process optimization or troubleshooting applications.

Alternative Token Ledger 350 implementations provide options for realizing the resource accounting and incentivization mechanisms of the system. While permissioned blockchain implementations offer robust decentralized validation and immutable record-keeping, they introduce computational overhead and implementation complexity that may not be warranted in all deployment contexts. A centralized, cryptographically signed SQL database offers an alternative approach that maintains many of the security properties of blockchain-based systems while reducing computational requirements and simplifying deployment architecture.

In this implementation, each transaction record includes a timestamp, entity identifiers, resource descriptions, quantity information, and a cryptographic signature generated using the Governance Agent's private key. The signature covers all transactional fields, providing non-repudiation and tamper evidence without the consensus mechanisms of blockchain systems. Integrity verification occurs through signature validation against the Governance Agent's public key, potentially combined with periodic generation of integrity hashes that chain together transaction blocks to detect unauthorized modifications. This approach preserves the essential accounting and verification capabilities required by the token economy while reducing computational overhead and communication requirements.

Alternative Orchestration Logic can employ reinforcement learning policies instead of rule-based approaches for task allocation and resource management. These policies are trained to optimize global objectives—such as minimizing latency, maximizing resource utilization, or balancing workload distribution—through interaction with simulated system environments. The learning process involves exploring various allocation strategies, observing their outcomes, and progressively refining decision policies to improve performance against defined reward functions.

A significant advantage of learned orchestration policies is their ability to discover non-obvious patterns and relationships that might be missed in manually defined rules. For example, a reinforcement learning policy might learn that certain classes of prediction tasks perform better on specific types of hardware under particular load conditions, or that certain sequences of tasks benefit from locality-aware scheduling that minimizes data movement. These nuanced patterns can lead to better resource utilization and improved system performance compared to explicit rule-based approaches.

The reinforcement learning policies can be implemented using various architectures, such as Deep Q-Networks, Advantage Actor-Critic methods, or more recent approaches like Proximal Policy Optimization. The specific architecture is selected based on the complexity of the state and action spaces, the stability requirements of the deployment environment, and the need for explainability in decision-making. The policies are typically trained offline using simulation environments that model system behavior, then deployed with appropriate safety constraints and monitoring to ensure reliable operation.

Alternative Communication Protocols extend the system's applicability to challenging deployment environments such as remote monitoring stations, underground facilities, or areas with limited connectivity infrastructure. For ultra-low-bandwidth or intermittent connectivity scenarios, protocols specifically designed for constrained environments can be employed. Data Distribution Service for Extremely Resource-Constrained Environments (DDS-XRCE) provides a standardized approach for efficient, reliable communication with minimal overhead, suitable for battery-powered sensor platforms or remote monitoring locations with limited cellular connectivity.

This protocol implements publish-subscribe patterns with configurable quality-of-service policies that prioritize critical data while efficiently managing less time-sensitive information. Features such as automatic retransmission, data fragmentation and reassembly, and session management ensure reliable delivery even in challenging network conditions. The protocol's compact binary serialization minimizes bandwidth requirements, while its client-server architecture accommodates devices that may enter sleep states to conserve power, maintaining session state and message queues during inactive periods.

For environments with more extreme connectivity constraints, such as underground infrastructure or remote watershed monitoring locations, delay-tolerant networking approaches can be employed. These protocols maintain local operation during connectivity outages and implement store-and-forward mechanisms that buffer data until communication is reestablished. By separating application function from connectivity requirements, these approaches enable continuous operation and data collection even in environments where traditional networking assumptions do not hold.

Alternative AP 10 Embodiments can implement the Cognitive Agent Logic 50 through different computational approaches based on deployment constraints and application requirements. For extremely resource-constrained environments where even lightweight neural networks might be prohibitive, symbolic AI techniques such as rule-based systems, decision trees, or fuzzy logic controllers can provide effective decision-making capabilities with minimal computational overhead. These approaches encode domain knowledge explicitly rather than learning it from data, potentially improving transparency and reducing computational requirements at the cost of reduced adaptability to novel conditions.

Hybrid approaches that combine symbolic reasoning with limited learning components represent another valuable alternative. For example, an AP 10 might employ explicit rule-based logic for safety-critical decisions while using small, specialized neural networks for pattern recognition or anomaly detection tasks. This division of responsibilities allows the system to leverage the strengths of both approaches—the reliability and transparency of symbolic methods for critical functions and the flexibility and pattern-recognition capabilities of neural approaches for appropriate subtasks.

For specialized applications with unique requirements, the AP architecture can accommodate domain-specific processing units optimized for particular tasks. For instance, in image processing applications such as drone-based infrastructure inspection, the AP 10 might incorporate specialized computer vision models optimized for detecting specific types of defects or anomalies. Similarly, for vibration analysis in equipment monitoring, the AP 10 might include specialized signal processing algorithms tailored to identifying specific failure modes or performance issues.

Alternative deployment topologies extend beyond the hierarchical structure described previously to accommodate diverse organizational and infrastructure contexts. For water/energy/transportation utilities with existing investments in edge computing infrastructure, a more horizontally distributed approach might be employed, with greater processing capability placed at the edge level and reduced reliance on centralized Hub resources. This approach can reduce communication latency and bandwidth requirements while potentially increasing system resilience to connectivity disruptions.

Conversely, for smaller utilities or those with limited internal IT infrastructure or expertise, a more centralized deployment model might be preferred. In this scenario, most processing occurs at the Hub level, with minimal processing at the edge Clusters. This centralized Hub could be hosted and managed by a trusted third party, outside the utility's direct IT governance. This approach simplifies deployment and maintenance for the utility while still providing the essential monitoring and prediction capabilities needed for effective operation. The modular nature of the system architecture accommodates these varying deployment preferences, including third-party hosted Hubs, without compromising core functionality.

Federated learning approaches represent an alternative to the centralized training paradigm described previously, particularly valuable for scenarios with data privacy concerns or distributed ownership of infrastructure assets. In this approach, model updates are computed locally using private data, with only parameter updates (rather than raw data) shared with central coordination points. These updates are aggregated to improve global models without exposing sensitive operational data. This approach can facilitate collaboration between different organizational entities while preserving data sovereignty and addressing privacy or competitive concerns.

Through these diverse alternative embodiments, the invention demonstrates its adaptability to varying implementation contexts, operational requirements, and infrastructure constraints. The core architectural principles-hierarchical agent organization, tri-tensor AP design, and dynamic orchestration based on health and capability metrics-remain applicable across these variations, providing a flexible foundation for advanced water infrastructure management (exemplary) across a wide range of deployment scenarios.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user's computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, and floppy drives, or any suitable device. The computer-executable component can be a processor but any suitable dedicated hardware device can (alternatively or additionally) execute the instructions.

As a person skilled in the art will recognize from the previous detailed description and the figures and claims, modifications and changes can be made to the embodiments of the invention without departing from the spirit and scope of this invention.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

### LIST OF REFERENCE NUMERALS

1: Hierarchical Digital-Twin System
10: Portable A gent-Package (AP) Apparatus
20: Physics-Surrogate World-Model (Mwm)
30: Connection-Memory (Mmem)
40: Emotion Tensor (Memo)
50: Cognitive A gent Logic
60: Goal/Reward Logic
70: Communication Interface (Bidirectional, Authenticated)
80: Packaged Tools
85: External Tools
90: External Event Client
100: System Deployment Hierarchy
110: Nexus Layer
120: Hub Layer
121, 122: Specific Hub Instances
130: Cluster Layer
140: Node Layer
150: A gent-Package (AP) (Generic instance)
151: Nexus Deployed A P
152: Hub Deployed A P
153: Cluster Deployed A P
160: Storage (General System Storage)
170: Communication Pathways/Network
200: Hub Server
210: Orchestration A gent(s)
220: User Interaction A gent(s)
222: Interface Routing A gent
224: Request/Response Processing A gent
230: Surrogate Factory (Hub-level instance)
235: M aster Mechanistic Model (MMM)
240: Data Ingestion Layer
250: Knowledge Access Module(s)
260: Communication Broker(s)
270: Policy/Reward Service
280: Edge Gateway
290: OTA & Container Registry
300: Nexus (Conceptual Layer Ref)
310: Supervisory A gent(s) (General)
312: Global Orchestrator (“Sheepdog”)
314: Creation A gent
316: Governance A gent
318: Archivist (Optional)
319: Risk Officer (Optional)
330: Integrated Surrogate Factory (Nexus-level)
340: Cross-Domain Orchestration (Function)
350: Token Ledger
400: Cluster-Edge Computing Unit(s)
410: Edge Processor
420: Local Storage/Experience Buffer
430: Cluster Deployed AP (Same as 153)
500: Sensor Node(s)
510: Sensor(s)
520: PLC/RTU
530: IoT Logger/IoT Sensor Input
540: External Data API Source
550: Timestamped Process Data/Measurements
560: Hard Sensor Input
570: Soft Sensor Input
580: Lab Data Source
600: Physics-Surrogate World Model (Mwm) (Instance)
605: Emulation Model
610: Mechanistic Model
615: M aster Mechanistic Model (MMM) (Same as 235)
620: Host System (Emulation)
622: Software Host
624: Hardware Host
630: Guest System (Emulation)
632: Software Guest
634: Hardware Guest
640: Surrogate Factory Workflow
642: Training Data
644: Validation Process/Step
646: Deployment Process/Step
648: M emo Feedback Loop
649: Residual Feedback Loop
650: Bioreactor Process (Example)
652: Influent (Example)
654: Effluent (Example)
660: Emulator Training Step
662: Input/Output Datasets
664: Observed Data Input
700: Connection Memory (M mem) (Overall)
710: Task Connection Memory
720: Experience Memory
730: Cluster Connection Memory
740: Domain Connection Memory
750: Policy/Reward Memory
760: Interface Connection Memory
770: Cross-Domain Connection Memory
780: System Connection Memory
790: Property Graph/Knowledge Graph
800: Spatial Coordinate (x, y, z)
805: Temporal Coordinate (t)
810: Coordinate Point/Cell (x, y, z, t)
820: Integrated Environmental System
822: Air Coordinates Domain
824: Surface Coordinates Domain
826: Surface Water Coordinates Domain
828: Subsurface Coordinates Domain
830: Built Environment Coordinates Domain
840: Watershed/Airshed/Energyshed Model
842: Climate Model
844: Collection System Model
846: Treatment Plant Model
850: Data Transformation Packet/Function
860: Spatial Scale Metadata
865: Temporal Step Metadata
870: Infrastructure Process Units/Longitudinal Model Chain
872: Mechanistic Model Chain
875: Mixed Emulation Model Chain
880: 3D Cellular Twin Representation
881: 3D Space
882: Mechanistic Coordinate Units
883: Emulation Units (Em)
884: Emulated Cell (Aggregated)
885: Coordinate Transfer Workflow
886: Time Steps
890: Integrated Digital Twin Emulation Model
895: Control Action Component/Output
900: User Interface (General)
910: Multi-Modal User Interaction
912: Digital Home Base/Web Application
914: Natural Language Interface
916: Mobile Application Interface
918: Dashboard/Report Interface
930: Communication Interface (AP level, same as 70)
940: Communication Broker (Hub level, same as 260)
950: Standardized Semantic Envelope (MCP/A2A)
960: Transport Protocol
970: Multi-Agent Orchestration Module

What is claimed is:

1. A portable agentic or agent-package apparatus configured for operative coupling to one or more environment, energy or water-infrastructure or water body sensors that produce timestamped or temporal process data, the apparatus comprising:
a. a physics-surrogate world-model (Mwm) trained to predict at least one hydraulic, chemical, or biological state variable of the sensed water system;
b. a connection-memory (Mmem) that stores at least one of (i) metadata describing data-source identifiers, units, and sampling cadence, (ii) pointers to available analytical tools or peer agent-packages, or (iii) streams of operational experience or a hierarchical options library;
c. an emotion tensor (Memo) that continuously encodes normalized metrics comprising at least one of model-accuracy, computational-load, data-quality, latency, uncertainty, or further including an exploration-bonus channel, a value-estimate error, an anomaly score, or an alignment-divergence flag; and
d. a bidirectional, authenticated communication interface that (i) receives the temporal or timestamped process data from the one or more sensors, (ii) transmits Memo updates, and (iii) accepts goal directives, wherein the apparatus is further programmed to at least one of:
i. execute the physics-surrogate world-model (Mwm) on the received process data to generate a prediction,
ii. update the emotion tensor with a rolling error residual between the prediction and a subsequently received ground-truth value, or with an indicator of prediction uncertainty or value estimation error, and
iii. modify a local control output or escalate a task to a peer agentic or agent-package when a selected Memo dimension exceeds a predefined threshold, or adjust an internal policy online from a stream of environmental reward signals.

2. The apparatus of claim 1, wherein the physics-surrogate world-model (Mwm) further comprising a neural network selected from the group consisting of a graph neural operator, a Fourier neural operator, or a physics-informed neural network, or comprises an emulator derived from a mechanistic model, a Diffusion Surrogate, a differentiable lattice-Boltzmann solver, or a foundation-model adapter fine-tuned on operational technology data.

3. The apparatus of claim 1, wherein the connection-memory (Mmem) executable on a centralized or edge, and is implemented as a property-graph database or a streaming temporal knowledge graph resident on the apparatus, or supports vector and symbolic fusion with embedding fingerprints for similarity search, or incorporates built-in graph reasoning capabilities.

4. The apparatus of claim 1, wherein the bidirectional, authenticated communication interface supports MQTT over TLS, gRPC over TLS, or DDS-XRCE, selected automatically according to available bandwidth, or utilizes a uniform semantic envelope conveyed over a transport protocol selected from the group consisting of gRPC, MQTT, DDS-XRCE, BLE mesh, or Wi-SUN.

5. The apparatus of claim 1, further comprising a side-car hardware-probe that detects a GPU, NPU, FPGA, or CPU-only environment and auto-selects an execution backend for the physics-surrogate world-model (Mwm), or wherein the apparatus is packaged as an Open Container Initiative (OCI) image including optional FPGA bitstreams or targeting WebAssembly or WebGPU environments.

6. The apparatus of claim 1, wherein the apparatus performs on-device fine-tuning or adaptation of the physics-surrogate world-model (Mwm) by adjusting a low-rank adapter layer or applying lightweight online learning techniques selected from the group consisting of Elastic Weight Consolidation or RePTile-style meta-updates when Memo accuracy drifts or the Exploration Bonus exceeds a set point.

7. The apparatus of claim 1, wherein the physics-surrogate world-model (Mwm) is configured to support on-device look-ahead planning or scenario evaluation by executing rapid Monte-Carlo rollouts or simulations, or includes a grounded-reward head configured to estimate cumulative operational reward derived from measurable Key Performance Indicators (KPIs).

8. The apparatus of claim 1, further comprising a Goal/Reward Logic configured to interpret received task directives (Mgoals) expressed in a model-context protocol, and compute rewards (Mrews) based on execution outcomes, wherein the Mrew is computed from one or more measurable operational KPIs, alone or in learned combinations tuned by high-level policy, or wherein a bi-level reward network maps user feedback or grounded KPIs to reward signals.

9. The apparatus of claim 1, wherein the local control output drives an aeration blower, chemical-dosing pump, or variable-speed lift-station pump, or wherein the connection-memory (Mmem) includes an Experience Memory implemented as a prioritized ring buffer or reservoir used for on-device policy updates.

10. A hierarchical digital-twin system for prediction and decision support in environment, energy or water infrastructure, comprising:
a. a plurality of sensor nodes that publish authenticated raw measurements;
b. a plurality of cluster-edge compute units each hosting at least one agentic or agent-package apparatus;
c. at least one hub server hosting at least one of (i) an orchestration agent configured to decompose high-level requests into task goals and to allocate task goals to selected agents or agent-packages based on their respective emotion tensor (Memo) values, and (ii) a surrogate-factory service that trains or retrains a physics-surrogate world-model (Mwm) when residual error data streamed from the agent-packages exceeds a threshold or when a Memo-based priority condition is met; and
d. an optional nexus layer hosting one or more supervisory agents selected from the group consisting of a Global Orchestrator, a Creation Agent, or a Governance Agent, wherein task directives (Mgoals), Memo updates, and model artefacts are exchanged between layers in a uniform semantic envelope conveyed over MQTT, gRPC, or DDS-XRCE.

11. The system of claim 10, wherein each cluster-edge compute unit meets a minimum specification of ≥4 ARM-64 CPU cores, ≥4 GB RAM, and dual Ethernet or LTE connectivity, or wherein the system supports container-based migration of agent-package apparatuses between different compute resources or hierarchical layers based on Memo status.

12. The system of claim 10, wherein the orchestration agent calculates a multi-objective score equal to w1·(1−accuracy)+w2·load−w3·explore or wT·Memo−λ·Uncertainty+κ·Explore for each candidate agent-package and allocates the task directives (Mgoals) to the agent-package with the lowest score or based on a reinforcement learning policy.

13. The system of claim 10, wherein, a surrogate-factory prioritizes retraining using a priority queue keyed to Memo accuracy, data quality, uncertainty, or alignment-flag magnitude, or supports federated fine-tuning or self-generated counter-scenario augmentation using diffusion models or a Scenario Forge component.

14. The system of claim 10, wherein the optional nexus layer includes a governance agent that maintains a cryptographically signed token ledger accounting for compute consumption or contributions of resources made by each hub, wherein contributed resources are selected from the group consisting of validated surrogate models, learned operational strategies, or federated model updates.

15. The system of claim 10, further comprising a user-interaction agent that converts natural-language queries into structured task goals and returns answers as concise text, graphical plots, or PDF reports, or wherein a connection-memory (Mmem) includes an Interface Connection Memory mapping communication channels and formats for multi-modal user interfaces.

16. The system of claim 15, wherein the connection-memory (Mmem) at the hub stores scale-conversion edges that automatically mediate data between models operating at different temporal or spatial scales, or wherein the tiered structure of the connection-memory (Mmem) facilitates multi-scale model mediation enabling integration of models selected from the group consisting of a climate model, a watershed model, a collection-system model, or a treatment-plant model.

17. The system of claim 14, wherein the optional nexus layer includes a Governance Agent configured to adapt federated learning aggregation frequency based on global Memo drift, or enforce self-evolution safety guardrails requiring agent mutations to pass counterfactual replay tests.

18. The system of claim 17, wherein the optional nexus layer includes a Creation Agent configured to synthesize new types of agent-package apparatuses or cross-domain workflows, or orchestrate federated learning processes, or includes a Global Orchestrator configured to coordinate distributed decision-making via a multi-objective auction or act as a Curriculum Scheduler for pairing agents for self-play.

19. A computer-implemented method for continuous learning and calibration in a hierarchical digital-twin system, the method comprising:
a. executing, by an at least one agentic or agent-package, the agentic or agent-package having a physics-surrogate world-model (Mwm) prediction using-sensor data;
b. computing a prediction residual between a prediction and an observed ground-truth value and updating at least one dimension of an emotion tensor (Memo) of the agent-package apparatus, or computing a prediction uncertainty or a value estimation error and updating the emotion tensor (Memo);
c. streaming the prediction residual together with the updated emotion tensor (Memo) to a hub-resident surrogate-factory;
d. adding the streamed prediction residual to a training buffer and, when a Memo-based priority condition is met, retraining or fine-tuning the physics-surrogate world-model (Mwm), wherein retraining prioritizes models based on emotion tensor (Memo) signals including Accuracy, Data Quality, Uncertainty, or Alignment Flag;
e. validating the retrained physics-surrogate world-model (Mwm) against held-out data or a master mechanistic model and, upon success, packaging the retrained model as a signed artefact, wherein validation includes replaying the retrained model against a hazard benchmark or rare-event scenario; and
f. deploying the signed artefact back to the at least one agent-package apparatus via an over-the-air hot-swap update.

20. The method of claim 19, wherein step (d) uses experience-weighted re-sampling that favours prediction residuals exceeding one standard deviation of recent error or weighted by TD-error or uncertainty, or wherein step (f) updates only a low-rank adapter layer or final output head of the physics-surrogate world-model (Mwm) when full-model replacement is unnecessary, or wherein the method further comprises updating a token ledger to credit a contributing hub with tokens proportional to downstream utilization of the deployed model, or wherein the method implements a continuous learning and calibration loop that continuously improves model accuracy or refines optimization strategies based on operational feedback without human intervention.
